(19) United States
(12) Patent Application Publication
(10) Pub. No.: US 2023/0403617 A1
(43) Pub. Date: Dec. 14, 2023

(54) MANAGING INTEGRATED ACCESS AND BACKHAUL MOBILITY

(71) Applicant: GOOGLE LLC, Mountain View, CA (US)

(72) Inventors: Chih-Hsiang Wu, Taoyuan City (TW); Ching-Jung Hsieh, Mountain View, CA (US)

(21) Appl. No.: 18/033,547

(22) PCT Filed: Oct. 22, 2021
(86) PCT No.: PCT/US21/56359

§ 371 Date: Apr. 24, 2023

Related U.S. Application Data
(60) Provisional application No. 63/104,483, filed on Oct. 22, 2020.

(51) Int. Cl. H04W 36/08; H04W 36/36

(52) U.S. Cl. CPC H04W 36/08; H04W 36/362

(57) ABSTRACT

A source donor supports inter-donor migration of an integrated access backhaul (IAB) node from the source donor to a target donor, where the source donor and the target donor corresponding to respective nodes of a radio access network (RAN), and when a user equipment (UE) is in communication with the RAN via the IAB-node. The source donor transmits, to the target donor, a handover request message related to the IAB-node; receives, from the target donor, a handover request acknowledge message including an IAB-node configuration related to the inter-donor migration of the IAB-node; provides the IAB-node configuration to the IAB-node; and transmits downlink data for the UE to the target donor, for forwarding to the UE via the IAB-node.

### FIELD OF THE DISCLOSURE

This disclosure relates generally to wireless communications and, more particularly, to integrated access and backhaul (IAB) mobility management procedures such as topology change procedures, and the corresponding UE context management.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP specification TS 36.323) and New Radio (NR) (see 3GPP specification TS 38.323) provides sequencing of protocol data units (PDUs) in the uplink direction (from a user device, also known as a user equipment (UE), to a base station) as well as in the downlink direction (from the base station to the UE). Further, the PDCP sublayer provides signaling radio bearers (SRBs) and data radio bearers (DRBs) to the Radio Resource Control (RRC) sublayer. Generally speaking, the UE and a base station can use SRBs to exchange RRC messages as well as non-access stratum (NAS) messages, and can use DRBs to transport data on a user plane.

UEs can use several types of SRBs and DRBs. When operating in dual connectivity (DC), the cells associated with the base station operating the master node (MN) define a master cell group (MCG), and the cells associated with the base station operating as the secondary node (SN) define the secondary cell group (SCG). So-called SRB1 resources carry RRC messages, which in some cases include NAS messages over the dedicated control channel (DCCH), and SRB2 resources support RRC messages that include logged measurement information or NAS messages, also over the DCCH but with lower priority than SRB1 resources. More generally, SRB1 and SRB2 resources allow the UE and the MN to exchange RRC messages related to the MN and embed RRC messages related to the SN, and also can be referred to as MCG SRBs. SRB3 resources allow the UE and the SN to exchange RRC messages related to the SN, and can be referred to as SCG SRBs. Split SRBs allow the UE to exchange RRC messages directly with the MN via lower layer resources of the MN and the SN. Further, DRBs using the lower-layer resources of only the MN can be referred as MCG DRBs, DRBs using the lower-layer resources of only the SN can be referred as SCG DRBs, and DRBs using the lower-layer resources of both the MCG and the SCG can be referred to as split DRBs.

The UE in some scenarios can concurrently utilize resources of multiple RAN nodes (e.g., base stations or components of a distributed base station), interconnected by a backhaul. When these network nodes support different radio access technologies (RATs), this type of connectivity is referred to as Multi-Radio Dual Connectivity (MR-DC). When a UE operates in MR-DC, one base station operates as a master node (MN) that covers a primary cell (PCell), and the other base station operates as a secondary node (SN) that covers a primary secondary cell (PSCell). The UE communicates with the MN (via the PCell) and the SN (via the PSCell). In other scenarios, the UE utilizes resources of one base station at a time. One base station and/or the UE determines that the UE should establish a radio connection with another base station. For example, one base station can determine to hand the UE over to the second base station, and initiate a handover procedure.

3GPP technical specifications (TS) 36.300 and 38.300 describe procedures for handover (also called reconfiguration with sync) scenarios. These procedures involve messaging (e.g., RRC signaling and preparation) between RAN nodes that generally causes latency, which in turn increases the probability of failure for handover procedures. 3GPP specification TS 37.340 v16.1.0 describes procedures for a UE to add or change an SN in DC scenarios. These procedures involve messaging (e.g., RRC signaling and preparation) between radio access network (RAN) nodes.

UEs can also perform handover procedures to switch from one cell to another, whether in single connectivity (SC) or DC operation. The UE may handover from a cell of a first base station to a cell of a second base station, or from a cell of a first distributed unit (DU) of a base station to a cell of a second DU of the same base station, depending on the scenario. 3GPP specifications 38.401 v15.6.0, 36.300 v15.6.0 and 38.300 v15.6.0 describe a handover procedure that includes several steps (RRC signaling and preparation) between RAN nodes, which causes latency in the handover procedure and therefore increases the risk of handover failure. This procedure, which does not involve triggering conditions that are checked at the UE, can be referred to as an “immediate” handover procedure.

More recently, for handover, SN addition/change, or PSCell addition/change, “conditional” procedures have been considered (i.e., conditional handover, conditional SN addition/change, or conditional PSCell addition/change). For example, scenarios involving conditional handover procedures are described in 3GPP specifications 36.300 and 38.300 v16.3.0. Unlike the “immediate” mobility procedures discussed above, these conditional mobility procedures do not perform the handover, or add or change the SN or PSCell, until the UE determines that a condition is satisfied. As used herein, the term “condition” may refer to a single, detectable state or event (e.g., a particular signal quality metric exceeding a threshold), or to a logical combination of such states or events (e.g., “Condition A and Condition B,” or “(Condition A or Condition B) and Condition C”, etc.).

To configure a conditional procedure, the RAN provides the condition to the UE, along with a configuration (e.g., one or more random-access preambles, etc.) that will enable the UE to communicate with the appropriate base station, or via the appropriate cell, when the condition is satisfied. For a conditional addition of a base station as an SN or a candidate cell as a PSCell, for example, the RAN provides the UE with a condition to be satisfied before the UE can add that base station as the SN or that candidate cell as the PSCell, and a configuration that enables the UE to communicate with that base station or PSCell after the condition has been satisfied. The configuration associated with the condition is at times referred to herein as the “conditional configuration” or “conditional reconfiguration”. 3GPP specifications 36.331 and 38.331 v16.3.0 describe a data structure a base station can use to indicate a conditional (re)configuration, and a condition to be satisfied prior to applying the conditional configuration, respectively.

3GPP TS 38.401 and 38.300 describe another RAN architecture and components of a distributed gNB RAN node. A gNB Central Unit (gNB-CU) is a logical node hosting RRC, SDAP, and PDCP protocols of the gNB, or RRC and PDCP protocols of the en-gNB, that controls the operation of one or more gNB-DUs. The gNB-CU terminates the F1 interface connected with the gNB-DU. The gNB Distributed Unit (gNB-DU) is a logical node hosting RLC, MAC, and PHY layers of the gNB or en-gNB, and its operation is partly controlled by gNB-CU. One gNB-DU supports one or multiple cells. One cell is supported by only one gNB-DU. The gNB-DU terminates the F1 interface connected with the gNB-CU.

Generally speaking, integrated access and backhaul (IAB) enables wireless relaying in a radio access network (RAN). A relaying node, referred to as an IAB-node, supports access and backhauling via New Radio (NR). The terminating node of NR backhauling on the network side is referred to as the IAB-donor, which represents a base station with additional functionality to support IAB. Backhauling can occur via a single or via multiple hops, so that a user equipment (UE) communicates with the RAN via one IAB-node, two IAB-nodes, or more IAB-nodes, and an IAB-donor. The IAB-donor provides network access to UEs via a network of backhaul and access links.

An IAB-donor can implement distributed architecture and include an IAB-donor-CU and one or more IAB-donor-DUs. In a 5G network architecture, the IAB-donor-CU is the gNB-CU of an IAB-donor, terminating the F1 interface with IAB-nodes and IAB-donor-DU. The IAB-donor-DU can be the gNB-DU of an IAB-donor. The IAB-donor-DU can host an IAB BAP sublayer (as defined in TS 38.340 Backhaul Adaptation Protocol (BAP), v. 16.1.0), providing wireless backhaul to IAB-nodes.

An IAB-node is a RAN node that can support NR access links to UEs and NR backhaul links to parent node(s) and child node(s). The parent node can be an IAB-node or an IAB-donor, and the child node is an IAB-node. The IAB-node supports gNB-DU functionality, as defined in TS 38.401 v. 15.5.0, to terminate the NR access interface to UEs and next-hop IAB-nodes, and to terminate the F1 protocol to the gNB-CU functionality, as defined in TS 38.401, at the IAB-donor. The gNB-DU functionality at the IAB-node is also referred to as IAB-DU. An IAB node routes IP traffic of an IAB-DU over the wireless backhaul via the BAP sublayer. In addition to the gNB-DU functionality, the IAB-node also supports a subset of the UE functionality referred to as IAB mobile terminal (IAB-MT). This functionality includes, for example, physical layer, layer-2, RRC, and NAS functionality to connect to the gNB-DU of another IAB-node or the IAB-donor, to connect to the gNB-CU of the IAB-donor, and to the core network.

All IAB-nodes that are connected to an IAB-donor via one or multiple hops form a directed acyclic graph (DAG) topology with the IAB-donor at the root. According to this DAG topology, the neighbor node on the interface of the IAB-DU is referred to as child node, and the neighbor node on the interface of the IAB-MT is referred to as parent node. The direction toward the child node is referred to as downstream, while the direction toward the parent node is referred to as upstream. The IAB-donor performs centralized resource, topology, and route management for the IAB topology.

For backhaul transport in IAB, the IAB-node routes IP traffic of the IAB-DU over the wireless backhaul, via the BAP sublayer. The BAP sublayer is specified in TS 38.340 v. 16.1.0. In the downstream direction, the BAP sublayer encapsulates upper-layer packets of the IAB-donor-DU and de-encapsulates the packets at the destination IAB-node. In the upstream direction, the BAP layer encapsulates upper-layer packets at the IAB-node and de-encapsulates the packets at the IAB-donor-DU. IAB-specific transport between IAB-donor-CU and IAB-donor-DU is specified in TS 38.401. The BAP sublayer routes packets based on the BAP routing ID in the BAP header. The communication stack adds the BAP header to the packet when the packet arrives from upper layers, and removes the BAP header when the packet has reached its destination node. The IAB-donor-CU selects and configures a BAP routing ID for a packet. The BAP routing ID has a BAP address and BAP path ID, where the BAP address indicates the destination node of the packet on the BAP sublayer, and the BAP path ID indicates the routing path the packet should follow to this destination. To support routing, each IAB-node and IAB-donor-DU has a respective designated BAP address.

There are several types of UE associations in an NG-RAN node. The NG-RAN node UE context stores all information needed for a UE and the associations between the UE and the logical NG and Xn connections used for NG/XnAP UE associated messages. The NG-RAN node UE context is a block of information in an NG-RAN node associated with one UE when the UE is in the CM_CONNECTED state. This block of information contains the information required to maintain the NG-RAN services for the active UE. An NG-RAN node establishes an NG-RAN node UE context when the UE completes the transition to the RRC CONNECTED state, after completion of handover resource allocation during handover preparation. In the latter case, at least UE state information, security information, UE capability information, and the identities of the UE-associated logical NG-connection are included in the NG-RAN node UE context. For dual connectivity, an S-NG-RAN establishes an NG-RAN node UE context after completion of an S-NG-RAN node Addition Preparation procedure. If a UE Context setup or modification procedure involves set up of radio bearers, the UE capabilities are provided to the receiving node as part of the UE context setup or modification procedures.

A bearer context is a block of information in a gNB-CU-UP node associated with one UE. The bearer context is used for communication over the E1 interface. The bearer context may include information about data radio bearers, PDU sessions, and QoS-flows associated with the UE. The block of information contains the information required to maintain user-plane services for the UE.

Further, UE-associated logical NG/Xn/F1/E1-connection NGAP, XnAP, F1AP, and E1AP provide means to exchange control plane messages associated with the UE over the NG-C, Xn-C, F1-C, and E1 interfaces, respectively. A UE-associated logical connection is established during the first NGAP/XnAP/F1AP message exchange between the NG/Xn/F1 peer nodes. The network maintains the connection as long as nodes need to exchange UE-associated NG/XnAP/F1AP messages over the NG/Xn/F1 interface. The UE-associated logical NG-connection uses the identities AMF UE NGAP ID and RAN UE NGAP ID. The UE-associated logical Xn-connection uses the identities Old NG-RAN node UE XnAP ID and New NG-RAN node UE XnAP ID, or M-NG-RAN node UE XnAP ID and S-NG-RAN node UE XnAP ID. The UE-associated logical F1-connection uses the identities gNB-CU UE F1AP ID and gNB-DU UE F1AP ID. When a node (AMF or gNB) receives a UE associated NGAP/XnAP/F1AP message the node retrieves the associated UE based on the NGAP/XnAP/F1AP ID.

In topology adaptation scenarios, the IAB-node may need to migrate (e.g., handover) from one parent node to another parent node to continue communicating with the RAN. When the IAB-node requires inter-donor migration (i.e., from one donor to another), it is not clear how IAB nodes and the IAB-donors should support the signalling, manage context, and modify the topology. Further, inter-donor migration may involve multiple IAB-nodes and/or multiple served UEs, which requires additional signalling to maintain session continuity during the migration. Still further, inter-donor migration can involve the use of multiple security keys corresponding to different respective nodes, and failure to apply the correct security can result in lost packets.

### SUMMARY

An example embodiment of the techniques of this disclosure is a method in a source donor for supporting inter-donor migration of an integrated access backhaul (IAB) node from the source donor to a target donor, the source donor and the target donor corresponding to respective nodes of a radio access network (RAN), when a user equipment (UE) is in communication with the RAN via the IAB-node. The method includes transmitting, by processing hardware to the target donor, a handover request message related to the IAB-node; receiving, by the processing hardware from the target donor, a handover request acknowledge message including an IAB-node configuration related to the inter-donor migration of the IAB-node; providing, by the processing hardware, the IAB-node configuration to the IAB-node; and transmitting downlink data for the UE to the target donor, for forwarding to the UE via the IAB-node.

Another example embodiment of the techniques is a method in a target donor for supporting inter-donor migration of an integrated access backhaul (IAB) node from a source donor to the target donor, the source donor and the target donor corresponding to respective nodes of a radio access network (RAN), when a user equipment (UE) is in communication with the RAN via the IAB-node. The method includes receiving, by processing hardware from the source donor, a handover request message related to the IAB-node; transmitting, by the processing hardware to the source donor, a handover request acknowledge message including an IAB-node configuration related to the inter-donor migration of the IAB-node; receiving downlink data for the UE from the source donor; and transmitting the downlink data to the UE via the IAB-node.

Still another example embodiment of these techniques is an IAB-donor in an integrated access backhaul (IAB) topology of a radio access network (RAN), the IAB-donor including processing hardware and configured to implement a method of any the preceding claims.

### BRIEF DESCRIPTION OF THE DRAWINGS

FIG. 1A is a block diagram of an example system in which a radio access network (RAN) supports IAB topology and can implement the techniques of this disclosure for managing inter-donor migration;

FIG. 1B is a block diagram of an example base station in which a centralized unit (CU) and a distributed unit (DU) that can operate in the system of FIG. 1A;

FIG. 2 is a block diagram of an example protocol stack according to which the UE or an IAB-MT of FIG. 1A communicates with base stations;

FIG. 3A is a block diagram of an example NG RAN that supports IAB functionality;

FIG. 3B is a block diagram of an example NG RAN that supports IAB functionality and provides multiple concurrent connections between an IAB-node and multiple donors;

FIG. 4A is a block diagram of example protocol stacks for user plane in an example NG RAN that supports IAB functionality;

FIG. 4B is a block diagram of example protocol stacks for control plane in an example NG RAN that supports IAB functionality;

FIG. 4C is a block diagram of example protocol stacks for IAB control plane traffic delivered via an MeNB, in an example NG RAN that supports IAB functionality;

FIG. 5A is a messaging diagram of an example scenario in which a UE and its serving IAB-node migrate from a source IAB-donor to a target IAB-donor, the source and target IAB-donors perform group handover (or migration), and the UE handover takes place before the IAB-node handover;

FIG. 5B is a messaging diagram of a scenario similar to that of FIG. 5A, but with the IAB node including multiple DUs;

FIG. 6A is a messaging diagram of an example scenario in which a UE and its serving IAB-node migrate from a source IAB-donor to a target IAB-donor, the source and target IAB-donors perform individual handover, and the UE handover takes place before the IAB-node handover;

FIG. 6B a messaging diagram of a scenario similar to that of FIG. 6A, but with the IAB node including multiple DUs;

FIG. 7A is a messaging diagram of an example scenario in which a UE and its serving IAB-node migrate from a source IAB-donor to a target IAB-donor, the source and target IAB-donors perform group handover, and the IAB-node handover takes place before the UE handover;

FIG. 7B a messaging diagram of a scenario similar to that of FIG. 7A, but with the IAB node including multiple DUs;

FIG. 8A is a messaging diagram of an example scenario in which a UE and its serving IAB-node migrate from a source IAB-donor to a target IAB-donor, the source and target IAB-donors perform individual handover, and the IAB-node handover takes place before the UE handover;

FIG. 8B a messaging diagram of a scenario similar to that of FIG. 8A, but with the IAB node including multiple Dus;

FIG. 9A is a messaging diagram of an example scenario in which a UE and its serving IAB-node migrate from a source IAB-donor to a target IAB-donor, the source and target IAB-donors perform individual handover, the IAB-node handover takes place before the UE handover, and the IAB-node connects to both the source and target IAB-donors during the inter-donor migration;

FIG. 9B a messaging diagram of a scenario similar to that of FIG. 9A, but with the IAB node including multiple Dus;

FIG. 10 is a flow diagram of an example method for forwarding the handover command to the IAB-node for the UE(s) and forwarding the handover complete to the target IAB-donor, which can be implemented in a source IAB-donor of this disclosure;

FIG. 11 is a flow diagram of an example method for generating and transmitting a handover command migrating the UE(s) and receiving a handover complete from the source donor node, which can be implemented in a target IAB-donor of this disclosure;

FIG. 12 is a flow diagram of an example method for performing the handover procedures with the UE(s) and the IAB-node and the data communication after the handover, which can be implemented in a target IAB-donor of this disclosure;

FIG. 13 is a flow diagram of an example method for performing the handover procedure with the UE(s) and the encryption of data communication after the handover, which can be implemented in a target IAB-donor of this disclosure;

FIG. 14 is a flow diagram of an example method for performing the handover procedure with the UE(s) and the encryption of signaling communication, which can be implemented in a source IAB-donor of this disclosure;

FIG. 15 is a flow diagram of an example method for performing the handover procedure and the encryption of signaling communication, which can be implemented in an IAB supported RAN of this disclosure;

FIG. 16 is a flow diagram of an example method for performing handover procedure for the IAB-node and the encryption and data forwarding of the UE data communication, which can be implemented in a source IAB-donor of this disclosure;

FIG. 17 is a flow diagram of an example method for determining the order in which UE handover and IAB-node handover should occur, depending on whether the handover procedure is immediate or conditional;

FIG. 18 is a flow diagram of an example method of supporting inter-donor migration of an integrated access backhaul IAB node, which can be implemented in a source donor of FIG. 1A;

FIG. 19 is a flow diagram of an example method of supporting inter-donor migration of an integrated access backhaul IAB node, which can be implemented in a target donor of FIG. 1A; and

FIG. 20 is a flow diagram of an example method of inter-donor migration, which can be implemented in an IAB-node of FIG. 1A.

### DETAILED DESCRIPTION OF THE DRAWINGS

In terms of topology adaptation scenarios, the IAB-node may need to migrate (e.g., handover) from one IAB-donor to another IAB-donor, or from one parent node to another parent node under same IAB-donor or a different IAB-donor to continue its connection. In 3GPP specifications for Rel-16, only the intra-donor migration procedure was discussed and captured for IAB. The inter-donor migration case is to be discussed in Rel-17 as a topology adaptation enhancement to address service robustness and load-balancing. Because the inter-donor migration may involve not only a single UE but a group of IAB-nodes and their served UEs, the incurred signalling load for such scenario could be considerable. During the inter-donor migration, the target IAB-donor may decide to keep all or part of the service topology maintained at the source IAB-donor; compared to the UE context management upon a single UE handover, the UE context handling for the IAB-donors and the migrating IAB-nodes needs some enhancements to reduce signalling. Unlike a normal gNB, because the IAB-donor may not be able to connect or reach the migrating IAB-node or UE directly, performing the inter-donor migration and the corresponding change of encryption keys for data requires some coordination between the source and target IAB-donors. Otherwise, the receiving side of the data may not be able to successfully decrypt the data because it may not hold the corresponding key during or after the migration. Additionally, because the migration may involve a hierarchy of intermediate IAB-nodes and UEs, the order of migration for the parent node and child nodes may not be clear.

In general, the techniques of this disclosure allow an IAB-node connected to a source IAB-donor to hand over to a target IAB-donor, and the target IAB-donor manages a service topology maintained at the source IAB-donor after the handover.

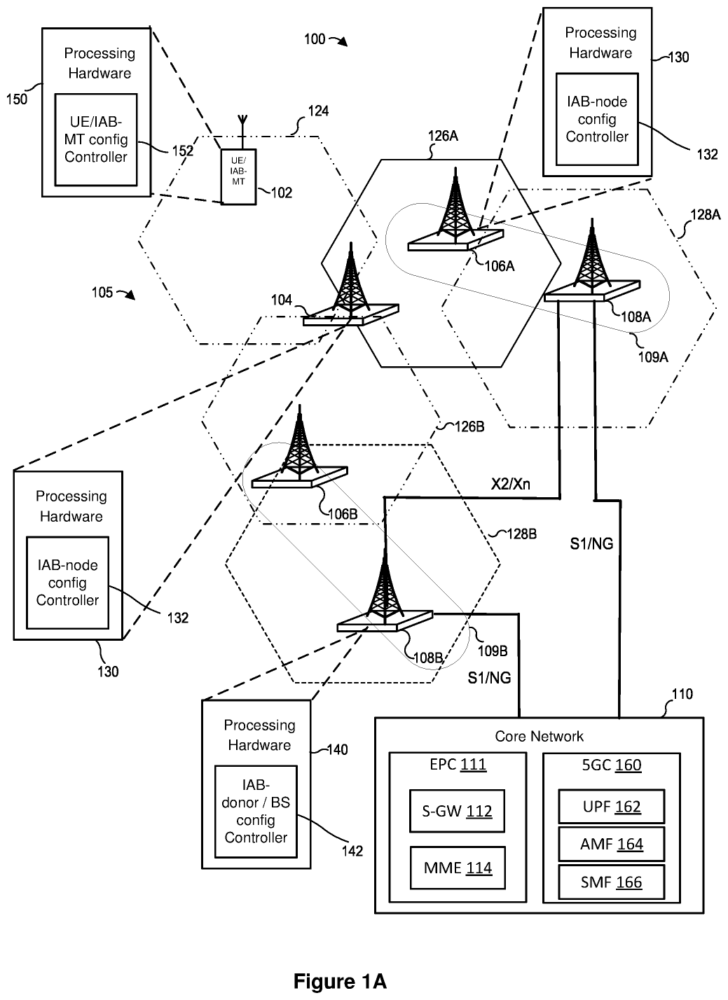

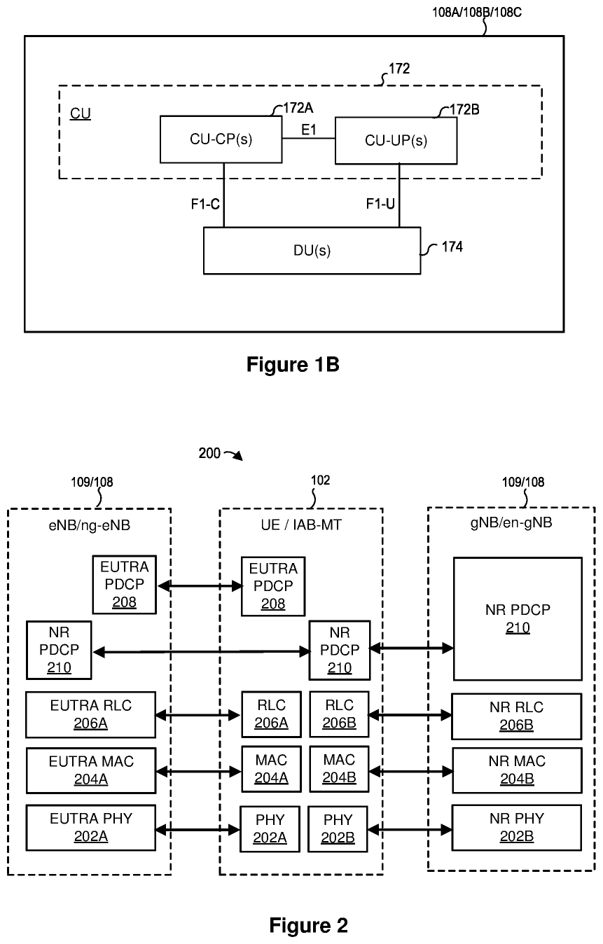

FIG. 1A depicts an example wireless communication system 100 in which communication devices can implement these techniques. The wireless communication system 100 includes a UE or an IAB-MT 102 (an IAB-node function that terminates the Uu interface to the parent node using the procedures and behaviors specified for UEs), an IAB-node 104, an IAB-node 106A, an IAB-node 106B, an IAB-donor 108A, an IAB-donor 108B and a core network (CN) 110. The UE/IAB-MT 102 initially connects to the IAB-donor 108A via the IAB-node 104.

In some scenarios, the IAB-donor 108A can perform an inter-donor migration (or handover) to configure the UE/IAB-MT 102 to connect with the IAB-donor 108B due to load-balancing, service robustness, or other reasons such as IAB-node mobility. In some implementation the inter-donor handover can be an immediate handover or a conditional handover.

More particularly, when the IAB-MT 102 receives a configuration to handover to IAB-donor 108B, an IAB-DU belonging to the same IAB-node with the IAB-MT may also receive UE Context Management messages for the descendant UE or IAB-node from the source IAB-donor 108A and/or the target IAB-donor 108B. The IAB-node 104 hosting the UE or IAB-MT 102 and IAB-DU manages the stored UE Contexts for the descendant UE or IAB-nodes according to the indications from the source IAB-donor and target IAB-donor.

In various configurations of the wireless communication system 100, the (intermediate) IAB-node 106A and the IAB-donor 108A can be implemented as a distributed base station 109A, and the (intermediate) IAB-node 106B and the IAB-donor 108B can be implemented as another distributed base station 109B. The UE or IAB-MT 102 can communicate with the base stations 109A, 109B via the same RAT such as EUTRA or NR, or different RATs. When the base station 109A is an MeNB and the base station 109B is a SgNB, the UE or IAB-MT 102 can be in EUTRA-NR DC (EN-DC) with the MeNB and the SgNB.

In some cases, an MeNB or an SeNB is implemented as an ng-eNB rather than an eNB. When the base station 109A is a Master ng-eNB (Mng-eNB) and the base station 109B is a SgNB, the UE or IAB-MT 102 can be in next generation (NG) EUTRA-NR DC (NGEN-DC) with the Mng-eNB and the SgNB. When the base station 109A is an MgNB and the base station 109B is an SgNB, the UE or IAB-MT 102 may be in NR-NR DC (NR-DC) with the MgNB and the SgNB. When the base station 109A is an MgNB and the base station 109B is a Secondary ng-eNB (Sng-eNB), the UE or IAB-MT 102 may be in NR-EUTRA DC (NE-DC) with the MgNB and the Sng-eNB.

In the scenarios where the UE or IAB-MT 102 hands over from the base station 109A to the base station 109B, the base stations 109A and 109B operate as the source base station (S-BS) and a target base station (T-BS), respectively.

The base stations 108A, 108B, 109A and 109B can connect to the same core network (CN) 110 which can be an evolved packet core (EPC) 111 or a fifth-generation core (5GC) 160. The base station 108A can be implemented as an eNB supporting an S1 interface for communicating with the EPC 111, an ng-eNB supporting an NG interface for communicating with the 5GC 160, or as a base station that supports the NR radio interface as well as an NG interface for communicating with the 5GC 160. The base station 108B can be implemented as an EN-DC gNB (en-gNB) with an S1 interface to the EPC 111, an en-gNB that does not connect to the EPC 111, a gNB that supports the NR radio interface as well as an NG interface to the 5GC 160, or a ng-eNB that supports an EUTRA radio interface as well as an NG interface to the 5GC 160. To directly exchange messages during the scenarios discussed below, the base stations 108A, 108B, 109A, and 109B can support an X2 or Xn interface.

Among other components, the EPC 111 can include a Serving Gateway (S-GW) 112 and a Mobility Management Entity (MME) 114. The S-GW 112 in general is configured to transfer user-plane packets related to audio calls, video calls, Internet traffic, etc., and the MME 114 is configured to manage authentication, registration, paging, and other related functions. The 5GC 160 includes a User Plane Function (UPF) 162 and an Access and Mobility Management (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 109A supports a cell 126A, the base station 109B supports a cell 126B. The cells 126A and 126B can partially overlap.

In general, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure also can apply to other suitable radio access and/or core network technologies such as sixth generation (6G) radio access and/or 6G core network or 5G NR-6G DC.

With continued reference to FIG. 1A, the IAB-node 104 includes processing hardware 130, which may include one or more general-purpose processors (e.g., central processing units (CPUs)) and a computer-readable memory storing machine-readable instructions executable on the general-purpose processor(s), and/or special-purpose processing units. The processing hardware 130 in the example implementation of FIG. 1 includes an IAB-node configuration controller 132 that is configured to manage or control the configuration techniques of this disclosure. For example, the IAB-node configuration controller 132 may be configured to provide and support lower layer configurations for an RRC message.

The base station 109B includes processing hardware 140, which may include one or more general-purpose processors (e.g., CPUs) and a computer-readable memory storing machine-readable instructions executable on the general-purpose processor(s), and/or special-purpose processing units. The processing hardware 140 in the example implementation of FIG. 1 includes an IAB-donor/base station configuration controller 142 that is configured to manage or control RRC procedures and RRC configurations for connected IAB-nodes and UEs. For example, the IAB-donor configuration controller 142 may be configured to support RRC messaging associated with handover procedures.

The UE or IAB-MT 102 includes processing hardware 150, which may include one or more general-purpose processors (e.g., CPUs) and a computer-readable memory storing machine-readable instructions executable on the general-purpose processor(s), and/or special-purpose processing units. The processing hardware 150 in the example implementation of FIG. 1 includes a UE/IAB-MT configuration controller 152 that is configured to manage or control RRC procedures and RRC configurations. For example, the configuration controller 152 may be configured to support RRC messaging associated with handover and/or secondary node addition/modification procedures in accordance with any of the implementations discussed below.

FIG. 1B depicts an example distributed implementation of any one or more of the IAB-donors 108A or 108B. In this implementation, any one of the IAB-donors includes a centralized unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures. The process hardware can also include a physical layer controller configured to manage or control one or more physical layer operations or procedures.

In some implementations, the CU 172 can include a logical node CU-CP 172A that hosts the control plane (CP) part of the Packet Data Convergence Protocol (PDCP) protocol of the CU 172 and/or radio resource control (RRC) protocol of the CU 172. The CU 172 can also include logical node(s) CU-UP 172B that hosts the user plane (UP) part of the PDCP protocol and/or Service Data Adaptation Protocol (SDAP) protocol of the CU 172.

The CU-CP 172A can be connected to multiple CU-UP 172B through the E1 interface. The CU-CP 172A selects the appropriate CU-UP 172B for the requested services for the UE 102. In some implementations, a single CU-UP 172B can be connected to multiple CU-CP 172A through the E1 interface. The CU-CP 172A can be connected to one or more DU 174s through an F1-C interface. The CU-UP 172B can be connected to one or more DU 174 through the F1-U interface under the control of the same CU-CP 172A. In some implementations, one DU 174 can be connected to multiple CU-UP 172B under the control of the same CU-CP 172A. In such implementations, the connectivity between a CU-UP 172B and a DU 174 is established by the CU-CP 172A using Bearer Context Management functions.

Next, FIG. 2 illustrates in a simplified manner a radio protocol stack according to which the UE or IAB-MT 102 can communicate with an eNB/ng-eNB or a gNB. Each of the base stations 109A, 109B, 108A, or 108B can be the eNB/ng-eNB or the gNB.

The physical layer (PHY) 202A of EUTRA provides transport channels to the EUTRA Medium Access Control (MAC) sublayer 204A, which in turn provides logical channels to the EUTRA Radio Link Control (RLC) sublayer 206A, and the EUTRA RLC sublayer in turn provides RLC channels to the EUTRA PDCP sublayer 208 and, in some cases, NR PDCP sublayer 210. Similarly, the PHY 202B of NR provides transport channels to the NR MAC sublayer 204B, which in turn provides logical channels to the NR RLC sublayer 206B, and the NR RLC sublayer 206B in turn provides RLC channels to the NR PDCP sublayer 210. The UE 102 in some implementations supports both the EUTRA and the NR stack, to support handover between EUTRA and NR base stations and/or DC over EUTRA and NR interfaces. Further, as illustrated in FIG. 2, the UE or IAB-MT 102 can support layering of NR PDCP 210 over EUTRA RLC 206A.

The EUTRA PDCP sublayer 208 and the NR PDCP sublayer 210 receive packets (e.g., from the Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 provide SRBs to exchange Radio Resource Control (RRC) messages, for example. On a user plane, the EUTRA PDCP sublayer 208 and the NR PDCP sublayer 210 provide DRBs to support data exchange.

When the UE or IAB-MT 102 operates in EUTRA/NR DC (EN-DC), with the base station 109A operating as a MeNB and the base station 109B operating as a SgNB, the network can provide the UE or IAB-MT 102 with an MN-terminated bearer that uses EUTRA PDCP 208 or MN-terminated bearer that uses NR PDCP 210. The network in various scenarios also can provide the UE or IAB-MT 102 with an SN-terminated bearer, which use only NR PDCP 210. The MN-terminated bearer can be an MCG bearer or a split bearer. The SN-terminated bearer can be a SCG bearer or a split bearer. The MN-terminated bearer can be an SRB (e.g., SRB1 or SRB2) or a DRB. The SN-terminated bearer can an SRB (e.g., SRB) or a DRB.

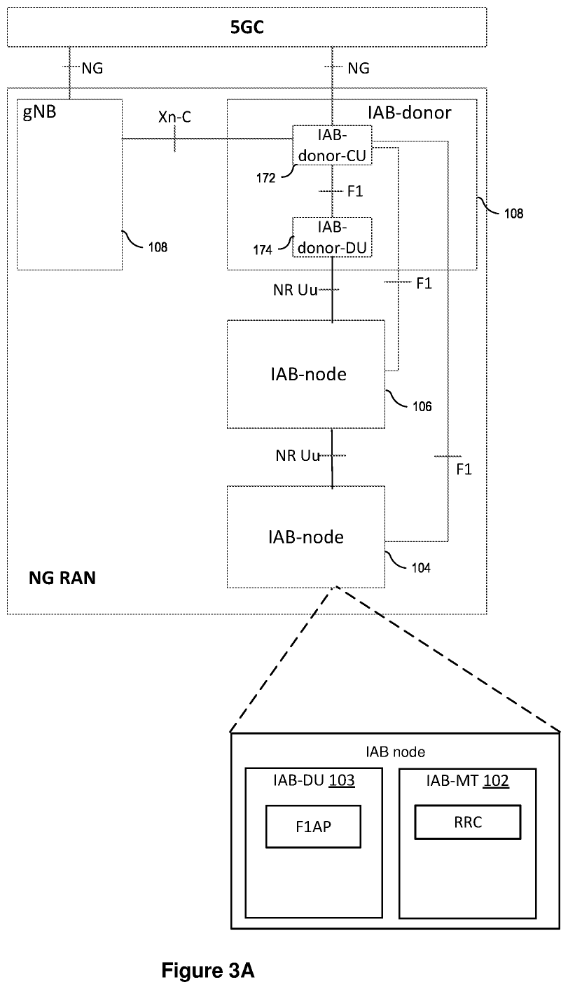

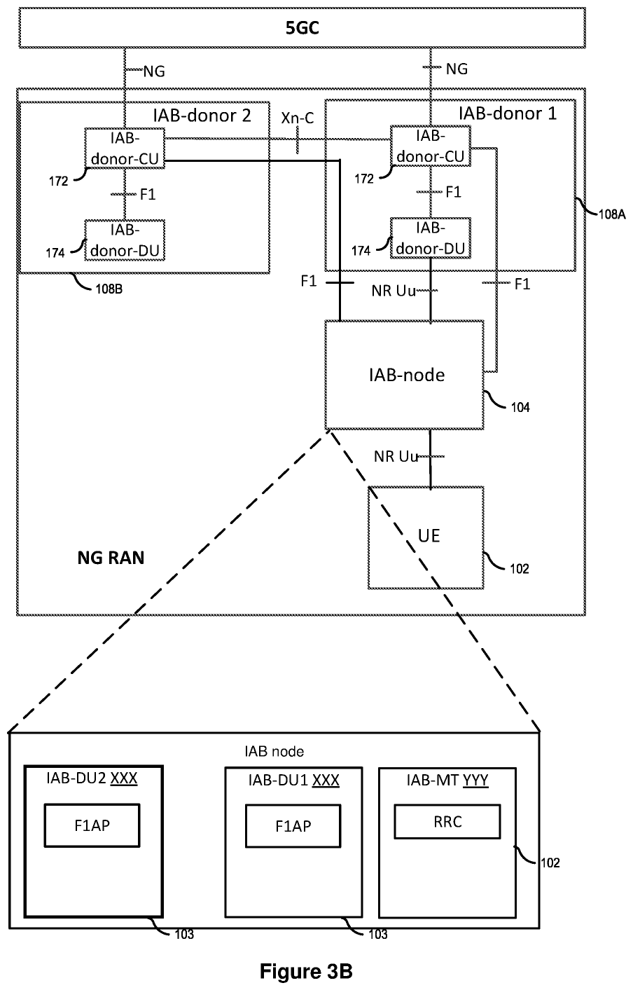

Next, FIGS. 3A and 3B illustrate an overall architecture of IAB based NG-RAN as defined in TS 38.401. The NG-RAN supports IAB by the IAB-node (e.g., 104, 106A or 106B) wirelessly connecting to the gNB capable of serving the IAB-nodes, named IAB-donor (e.g., 108A or 108B). The IAB-donor can have an IAB-donor-CU (e.g., 172) and one or more IAB-donor-DU(s) (e.g., 174). In case of separation of gNB-CU-CP and gNB-CU-UP, the IAB-donor can have an IAB-donor-CU-CP, multiple IAB-donor-CU-UPs, and multiple IAB-donor-DUs. The IAB-node connects to an upstream IAB-node or an IAB-donor-DU via a subset of the UE functionalities of the NR Uu interface (named IAB-MT (e.g., 102) function of IAB-node). The IAB-node provides wireless backhaul to the downstream IAB-nodes and UEs via the network functionalities of the NR Uu interface (named IAB-DU (e.g., 103) function of IAB-node). The F1-C traffic between an IAB-node and IAB-donor-CU is backhauled via the IAB-donor-DU and the optional intermediate hop IAB-node(s). The F1-U traffic between an IAB-node and IAB-donor-CU is backhauled via the IAB-donor-DU and the optional intermediate hop IAB-node(s). All functions specified for a gNB-DU are equally applicable for an IAB-DU (e.g., 103) and IAB-donor-DU (e.g., 103), unless otherwise stated, and all functions specified for a gNB-CU are equally applicable for an IAB-donor-CU, unless otherwise stated. All functions specified for the UE context are equally applicable for managing the context of IAB-MT, unless otherwise stated.

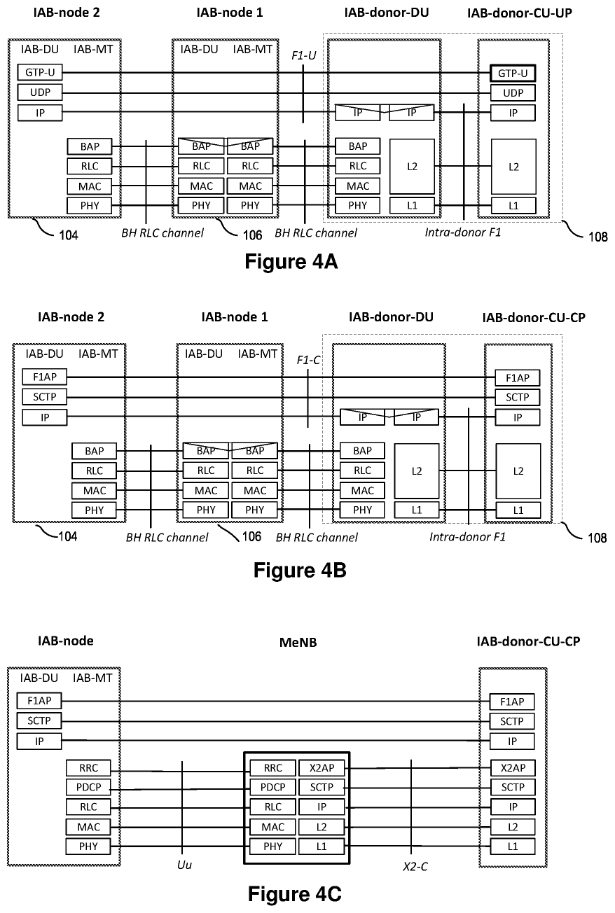

Next, FIGS. 4A, 4B, and 4C illustrate the protocol stacks of IAB. As defined in TS 38.401, FIG. 4A shows the protocol stack for F1-U between IAB-DU and the IAB-donor-CU-UP, and FIG. 4B shows the protocol stack for F1-C between IAB-DU and the IAB-donor-CU-CP. In these example figures, F1-U and F1-C traffic are carried over two backhaul hops. FIG. 4C shows the protocol stack for F1-C between IAB-DU and the IAB-donor-CU-CP, when the F1-C traffic is transmitted via the MeNB and the IAB-node is in EN-DC with the MeNB and an IAB-donor serving as SgNB.

Next, several example scenarios in which an IAB-donor initiates an inter-donor migration (e.g., handover) of its serving IAB-nodes and/or the descendant IAB-nodes and UEs. For simplicity, only an IAB-node (i.e., IAB-node 104) is shown in the following example scenarios, but it can be understood that the following procedures can apply to scenarios, that the IAB-node 104 connects to the UE 102 via one or more intermediate IAB-nodes. In other words, UE(s) including the UE 102 described in the below example scenarios can be regarded as the IAB-MT function of an intermediate IAB-node or regarded as a user device.

In the following description, “IAB-node 104” and “UE 102” can represent one or multiple IAB-nodes and UEs, respectively. In the case of multiple UEs, the procedures performed by the UE 102 can mean each of the multiple UEs performs the procedures, unless otherwise specified.

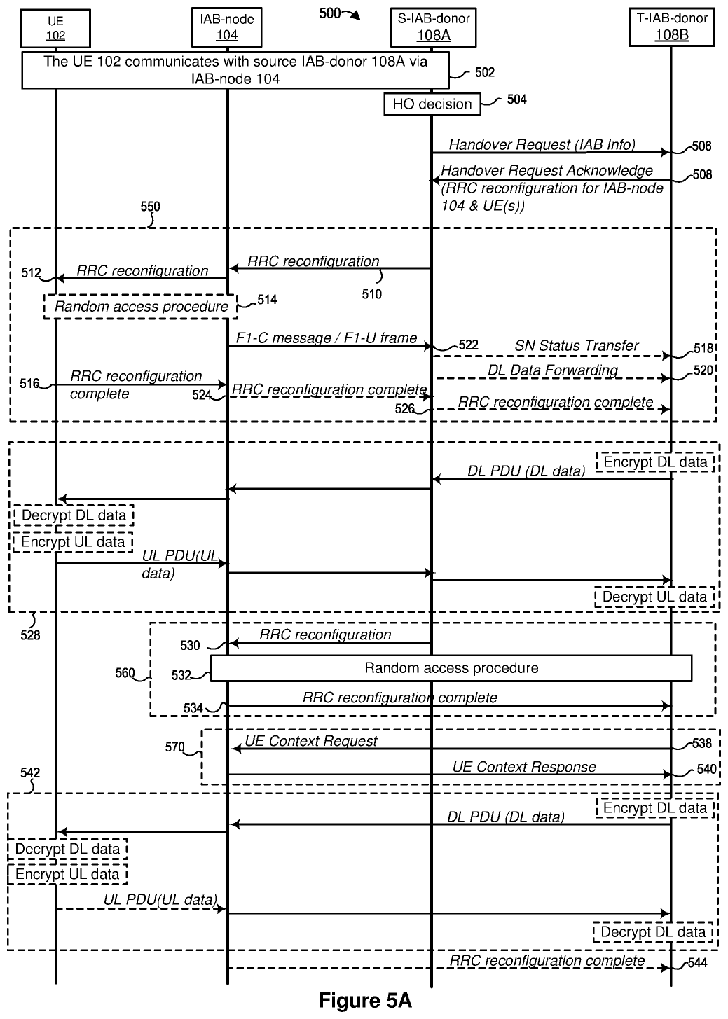

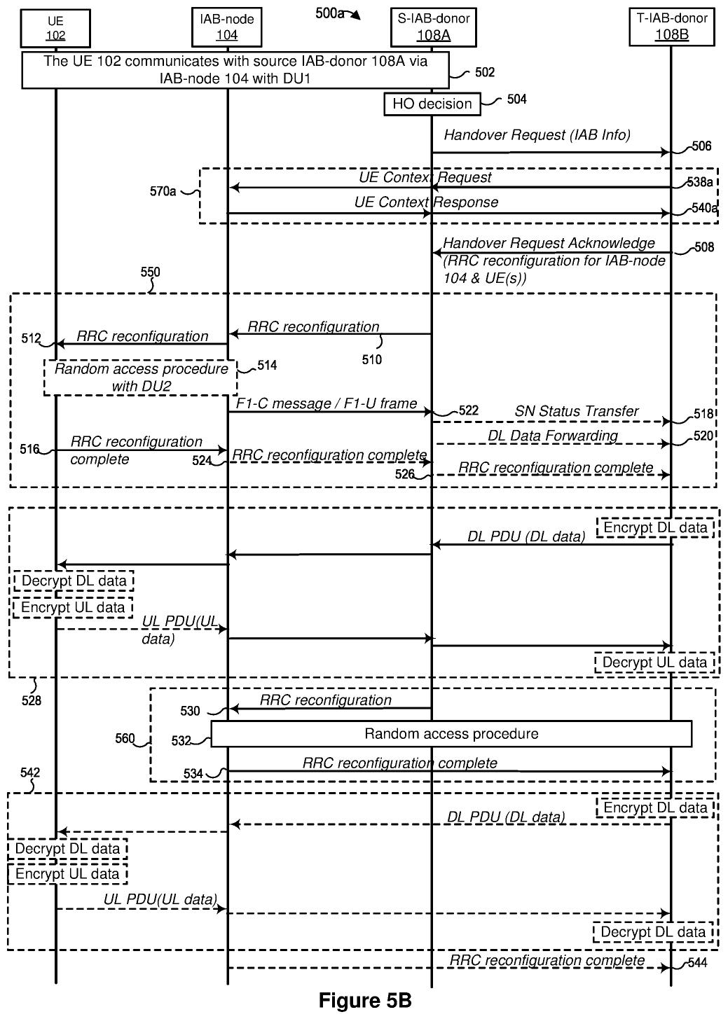

Referring first to FIG. 5, in a scenario 500, the source IAB-donor 108A serves UE 102 via an IAB-node 104. Initially, the UE 102 communicates 502 data (e.g., uplink and/or downlink PDUs) with the source IAB-donor 108A via the IAB-node 104, e.g., in accordance with a source IAB-donor configuration. In some scenarios and implementations, the UE 102 communicates 502 data with the source IAB-donor 108A via the IAB-node 104 and intermediate IAB-node(s) (e.g., IAB-node 106A) between the UE 102 and the IAB-node 104. In other scenarios and implementations, the UE 102 communicates 502 data with the source IAB-donor 108A via a single IAB-node, i.e., the IAB-node 104.

The source IAB-donor 108A at some point determines 504 that it should handover the IAB-node 104 and the UE 102 to the target IAB-donor 108B. The source IAB-donor can make this determination based on one or more measurement results received from the IAB-node 104 and/or the UE 102, for example, or another suitable event (e.g., topology change commanded by a network node such as an operation and maintenance (O&M) node). In response to this determination, the source IAB-donor sends 506 a Handover Request message to the target IAB-donor 108B.

In some implementations, in the Handover Request message, the source IAB-donor 108A includes a first source Access Stratum (AS) configuration for the IAB-node 104 and includes a second source AS configuration for the UE 102. At event 502, the IAB-node 104 uses the first source AS configuration to communicate with the source IAB-donor 108A, and the UE 102 uses the second source AS configuration to communicate with the IAB-node 104 or a descendant IAB-node of the IAB-node 104. In some implementations, the Handover Request message can include a first user plane setting such as Transport Network Layer information including Transport Layer Address and GTP-TEID for the IAB-node 104. The Handover Request message can also include a second user plane setting such as Transport Network Layer information including Transport Layer Address and GTP-TEID for the UE 102. In other implementations, the Handover Request message can further include a UE context for the IAB-node 104 and/or the IAB related information such as the backhaul and topology related information (e.g., BAP mapping configuration or aggregation of BAP mapping configuration for the serving IAB-nodes) and/or a UE context for other IAB-node(s) (e.g., intermediate IAB-node(s)) and/or UEs. In addition, the Handover Request message can include third source AS configuration(s) and/or a third user plane setting such as Transport Network Layer information including Transport Layer Address and GTP-TEID for the other IAB-node(s). The Handover Request message can include also fourth source AS configuration(s) for the other and/or a fourth user plane setting such as Transport Network Layer information including Transport Layer Address and GTP-TEID for the other UE(s).

In response to receiving the Handover Request message, the target IAB-donor 108B generates a RRC reconfiguration message for each of the IAB-node 104 (or more specifically, IAB-MT function of IAB-node 104) and UE(s) including UE 102 and includes the RRC reconfiguration messages in a Handover Request Acknowledge message and sends 508 the Handover Request Acknowledge message to the source IAB-donor 108A, in response to the Handover Request message 506, including the RRC reconfiguration messages for the IAB-node 104 (or more specifically, IAB-MT function of IAB-node 104) and UE(s) including UE 102. The target IAB-donor 108B can include data forwarding information in the Handover Request Acknowledge message so that the source IAB-donor 108A can use the data forwarding information to perform downlink data forwarding at event 520.

After receiving the Handover Request Acknowledge message 508, the source IAB-donor 108A firstly transmits the RRC reconfiguration messages for the UE(s) which are user device(s), then transmits the RRC reconfiguration messages for the UE(s) which are intermediate node(s) (if existing) and lastly transmits the RRC reconfiguration messages for the IAB-node 104. To transmit the RRC reconfiguration message for the UE 102, the source IAB-donor 108A performs security protection on the RRC reconfiguration message (e.g., protect integrity of the RRC reconfiguration message and/or encrypt the RRC reconfiguration message) by using first security key(s) and transmits 510 the RRC reconfiguration message to the IAB-node 104, which in turn transmits 512 the RRC reconfiguration message to the UE 102. In some implementations, the first security key(s) includes a first integrity key and/or a first encryption key. The source IAB-donor 108A performs integrity protection for the RRC reconfiguration message using the first integrity key to generate an integrity-protected RRC reconfiguration message (e.g., including the RRC reconfiguration message, and a message authentication code for integrity (MAC-I) generated from the RRC reconfiguration message and the first integrity key), encrypts the integrity-protected RRC reconfiguration message using the first encryption key, and sends 510 the encrypted and integrity-protected RRC reconfiguration message to the IAB-node 104. Then, the IAB-node 104 transmits 512 the encrypted and integrity-protected RRC reconfiguration message to the UE 102.

In some implementations, the source IAB-donor 108A can send 510 a UE Context Modification Request message or a DL RRC Message Transfer message including the (security protected) RRC reconfiguration message to the IAB-node 104. The IAB-node 104 can send a UE Context Modification Response message to the source IAB-donor 108A in response to the UE Context Modification Request message.

After receiving the (security protected) RRC reconfiguration message 512, the UE 102 decrypts and/or performs integrity check on the RRC reconfiguration message by using the first security key(s) (same as the first security key(s) used by the source IAB-donor 108A), and applies configuration parameters in the RRC reconfiguration message to hand over to the target IAB-donor 108B. In some implementations, the UE 102 can receive 512 this encrypted and integrity-protected RRC reconfiguration message, decrypt the encrypted and integrity-protected RRC reconfiguration message using the first encryption key to generate a decrypted integrity-protected RRC reconfiguration message, and finally perform the integrity check on the decrypted integrity-protected RRC reconfiguration message using the first integrity key to obtain the original RRC reconfiguration message (e.g. using the first integrity key to verify or validate the MAC-I).

In some implementations, the UE 102 may perform 514 a random access procedure, if instructed in the RRC reconfiguration message, with the IAB-node 104. In response to the RRC reconfiguration message, the UE 102 performs security protection on an RRC reconfiguration complete message by using second security key(s) and sends 516 the security protected RRC reconfiguration complete message to the IAB-node 104 during or after the random procedure (if performed). After transmitting the RRC reconfiguration message, performing the random access procedure, or receiving the RRC reconfiguration complete message 516, the IAB-node 104 can send 522 a F1-C message or a F1-U frame to the source IAB-donor 108A. In some implementation, the F1-C message or F1-U frame can be a Downlink (DL) Data Delivery Status frame as defined in 3GPP specification 38.425 or an Access Success message as defined in 3GPP specification 38.473.

In some implementations, the second security key(s) includes a second integrity key and/or a second encryption key. The UE 102 can derive or obtain the second security key(s) from information in the RRC reconfiguration message 512. The UE 102 performs integrity protection for the RRC reconfiguration complete message using the second integrity key to generate an integrity-protected RRC reconfiguration complete message (e.g., including the RRC reconfiguration complete message, and a message authentication code for integrity (MAC-I) generated from the RRC reconfiguration complete message and the second integrity key), encrypts the integrity-protected RRC reconfiguration complete message using the second encryption key, and sends 516 the encrypted and integrity-protected RRC reconfiguration complete message to the IAB-node 104.

In some implementations, the IAB-node 104 can immediately forward 524 the (security protected) RRC reconfiguration complete message to the source IAB-donor 108A, which in turn forwards 526 the RRC reconfiguration complete message to the target IAB-donor 108B. In other implementations, the IAB-node 104 may hold the (security protected) RRC reconfiguration complete message and sends 544 the RRC reconfiguration complete message to the target IAB-donor 108B after an IAB handover procedure 560. After the receiving the (security protected) RRC reconfiguration complete message 526, 544, the target IAB-donor 108B decrypts and/or performs integrity check on the RRC reconfiguration complete message by using the second security key(s) (same as the second security key(s) used by the UE 102). In some implementations, the target IAB-donor 108B can receive 526, 544 this encrypted and integrity-protected RRC reconfiguration complete message, decrypt the encrypted and integrity-protected RRC reconfiguration complete message using the second encryption key to generate a decrypted integrity-protected RRC reconfiguration complete message, and finally perform the integrity check on the decrypted integrity-protected RRC reconfiguration complete message using the second integrity key to obtain the original RRC reconfiguration complete message (e.g. using the second integrity key to verify or validate the MAC-I). In some implementations, the

In some implementations, the target IAB-donor 108B can send a Handover Success message to the source IAB-donor 108A to indicate that the UE 102 successfully hands over to the target IAB-donor 108B, after receiving the RRC reconfiguration complete message 526.

After transmitting 510 the RRC reconfiguration message, receiving 522 the F1-C message or F1-U frame or receiving Handover Success message, the source IAB-donor 108A may send 518 a SN Status Transfer message to transfer uplink PDCP SN and HFN receiver status and downlink PDCP SN and HFN transmitter status for DRB(s) of the UE 102 (if the DRB(s) uses an RLC Acknowledged Mode) and perform 520 downlink data forwarding. In the downlink data forwarding, the source IAB-donor 108A can send downlink data for the UE 102, that the source IAB-donor 108A received from CN 110, to the target IAB-donor 108B. The downlink data can be data packet(s) (e.g., Internet Protocol (IP) packet(s)) that the source IAB-donor 108A has not transmitted to the IAB-node 104. The data can be data packet(s) (e.g., IP packet(s)) that the source IAB-donor 108A has transmitted to the IAB-node 104 in format of PDUs (e.g., PDCP PDUs), and has not been acknowledged by the UE 102 or the IAB-node 104.

Before the IAB-node 104 hands over to the target IAB-donor 108B, the target IAB-donor 108B can transmit 528 downlink data for the UE 102, received at event 520 or from the CN 110, to the UE 102 via the source IAB-donor 108A and the IAB-node 104. More specifically, the target IAB-donor 108B performs security protection 528 on the downlink data (e.g., protect integrity of the downlink data and/or encrypt the downlink data) by using third security key(s) and transmits the security protected downlink data to the UE 102 via the source IAB-donor 108A and IAB-node 104. After receiving the security protected downlink data, the UE 102 decrypts 528 and/or performs 528 integrity check on the security protected downlink data by using the third security key(s) (same as the third security key(s) used by the target IAB-donor 108B) to obtain the original downlink data. The UE 102 can derive or obtain the third security key(s) from information in the RRC reconfiguration message 512.

In some implementations, the third security key(s) includes a third integrity key and a third encryption key. The target IAB-donor performs 528 integrity protection for a downlink data packet, received at event 520 or from the CN 110, using the third integrity key to generate an integrity-protected downlink data packet (e.g., including the downlink data packet, and a MAC-I generated from the downlink data packet and the third integrity key), encrypt 528 the integrity-protected downlink data packet using the third encryption key, and send 528 a downlink PDU including the encrypted and integrity-protected downlink packet to the UE 102 via the source IAB-donor 108A and IAB-node 104. After receiving the downlink PDU, the UE 102 extracts the encrypted and integrity-protected downlink packet, decrypt the encrypted and integrity-protected downlink packet using the third encryption key to generate a decrypted integrity-protected downlink packet, and finally perform the integrity check on the decrypted integrity-protected downlink packet using the third integrity key to obtain the original downlink data packet (e.g. using the third integrity key to verify or validate the MAC-I).

In other implementations, the third security key is a third encryption key. The UE 102 and the target IAB-donor 108B don't apply integrity protection in 528 data communication procedure. The target IAB-donor 108B encrypts 528 a downlink data packet, received at event 520 or from the CN 110, using the third encryption key, and sends 528 a downlink PDU including the encrypted downlink packet to UE 102 via the source IAB-donor 108A and IAB-node 104. After receiving 528 the downlink PDU including the encrypted downlink packet, the UE 102 extracts the encrypted downlink packet form the downlink PDU, and decrypts the encrypted data packet using the third encryption key to obtain the original downlink data packet.

After completing 514 the random access procedure or transmitting 516 the RRC reconfiguration procedure, the UE 102 can transmit 528 uplink data to the target IAB-donor 108B via the IAB node 104 and source IAB-donor 108A. More specifically, the UE 102 performs security protection on the uplink data (e.g., protect integrity of the uplink data and/or encrypt the uplink data) by using the third security key(s) and transmits the security protected uplink data to the target IAB-donor 108B via the IAB-node 104 and source IAB-donor 108A. After receiving the security protected downlink data, the target IAB-donor 108B decrypts 528 and/or performs 528 integrity check on the security protected uplink data by using the third security key(s) (same as the third security key(s) used by the UE 102) to obtain the original uplink data.

In some implementations, the UE 102 performs 528 integrity protection for an uplink data packet using the third integrity key to generate an integrity-protected uplink data packet (e.g., including the uplink data packet, and a MAC-I generated from the uplink data packet and the third integrity key), encrypt 528 the integrity-protected uplink data packet using the third encryption key, and send 528 an uplink PDU including the encrypted and integrity-protected uplink packet to the target IAB-donor 108B via the IAB-node 104 and source IAB-donor 108A. After receiving the uplink PDU, the target IAB-donor 108B extracts the encrypted and integrity-protected uplink packet, decrypt 528 the encrypted and integrity-protected uplink packet using the third encryption key to generate a decrypted integrity-protected uplink packet, and finally perform the integrity check on the decrypted integrity-protected uplink packet using the third integrity key to obtain the original uplink data packet (e.g. using the third integrity key to verify or validate the MAC-I).

In other implementations, the UE 102 and the target IAB-donor 108B don't apply integrity protection for downlink data received from the source IAB-donor 108A at event 520. The UE 102 encrypts 528 an uplink data packet using the third encryption key, and sends 528 an uplink PDU including the encrypted uplink data packet to target IAB-donor 108B via the IAB-node 104 and source IAB-donor 108A. After receiving 528 the uplink PDU including the encrypted uplink data packet, the target IAB-donor 108B extracts the encrypted uplink data packet form the uplink PDU, and decrypt 528 the encrypted data packet using the third encryption key to obtain the original uplink data packet.

The events 510, 512, 514, 516, 518, 520, 522, 524 and 526 can be collectively referred as a UE handover (or migration) procedure 550. The source IAB-donor 108A can perform a UE handover procedure for other UE(s) connecting to the source IAB-donor 108A via the IAB-node 104, similar to the UE handover procedure 550. The target IAB-donor 108B can perform a data communication procedure with each of the other UE(s), similar to the data communication procedure 528.

The source IAB-donor 108A, after migrating (e.g., handing over) all the UE(s) including UE 102, sends 530 an RRC reconfiguration message for the IAB node 104, received at event 508, to the IAB-node 104. The IAB-node 104 performs 532 a random access procedure, if instructed by the RRC reconfiguration message 530, with the target IAB-donor 108B. Then the IAB-node 104 sends 534 an RRC reconfiguration complete message to the target IAB-donor 108B during or after the random access procedure. The steps 530, 532, and 534 can be collectively referred as the IAB-node handover (or migration) procedure 560.

In some implementations and/or scenarios, the random access procedure 514, 532 can be a four-step random access procedure or a two-step random access procedure, for example. In different implementations and/or scenarios, the random access procedure 514, 532 may be a contention-based random access procedure or a contention-free random access procedure.

After the IAB-node 104 hands over to the target IAB-donor 108B, the target IAB-donor 108B sends 538 a UE Context Request message for the UE 102. In response, the IAB-node 104 can transmit 540 a UE Context Response message. The steps 538 and 540 can be collectively referred as a UE Context procedure 570 for the UE 102 and can be also performed for other UEs in the inter-donor migration. The target IAB-donor 108B can establish an UP association for a DRB of the UE 102 before, during or after the UE Context procedure 570, e.g., by transmitting a DL USER DATA frame to the IAB-node 104, so that the target IAB-donor 108B can perform 542 data communication procedure. If the target IAB-donor 108B performs multiple UE handover procedures (each is similar to the UE handover procedure 550) to hand over multiple UEs, the target IAB-donor 108B can perform a UE Context Setup procedure for each of the multiple UEs, similar to the UE Context Setup procedure 570. Alternatively, the target IAB-donor 108B can perform a single UE Context Setup Procedure for the multiple UEs, similar to the UE Context Setup procedure 570. In either alternative, the target IAB-donor 108B establishes an user-plane (UP) association for a DRB of each of the multiple UEs before, during or after the UE Context Setup procedure 570, e.g., by transmitting a DL USER DATA frame to the IAB-node 104 for each of the multiple UEs. Therefore, the target IAB-donor 108B can perform data communication procedure with each of the multiple UEs, similar to the data communication procedure 542. In some implementations, the IAB-node 104 can perform establishment of SCTP association(s) and/or F1 interface (e.g., F1 connection or F1 interface instance) with the target IAB-donor 108B so that the target IAB-donor 108B can performs the UE Context Setup procedure(s) on the F1 interface. For example, the IAB-node 104 can send a F1 SETUP REQUEST message to the target IAB-donor 108B to establish the F1 interface with the target IAB-donor 108B, and in response, the target IAB-donor 108B sends a F1 SETUP RESPONSE message to the IAB-node 104. After establishing the F1 interface, the target IAB-donor 108B can send the UE Context Request message over the F1 interface.

In some implementations, the IAB-node 104 includes, in the UE Context Response message, a lower-layer configuration (e.g., CellGroupConfig) for the UE 102. Then, the target IAB-donor 108B can generate an RRC reconfiguration message including the lower-layer configuration, perform security protection on the RRC reconfiguration message using the second security key(s) (e.g., protect integrity of the RRC reconfiguration message and/or encrypt the RRC reconfiguration as described above), and transmit the RRC reconfiguration message to the UE 102 via the IAB-node 104. In response to the RRC reconfiguration message, the UE 102 generates an RRC reconfiguration complete message, performs security protection on the RRC reconfiguration complete message using the second security key(s) (e.g., protect integrity of the RRC reconfiguration complete and/or encrypt the RRC reconfiguration complete as described above), and transmits the RRC reconfiguration message to the target IAB-donor 108B via the IAB-node 104. In other implementations, the IAB-node 104 does not, include in the UE Context Response message, a lower-layer configuration (e.g., CellGroupConfig) for the UE 102 (or each of the UEs) so that the target IAB-donor 108B does not transmit an RRC reconfiguration message.

After the UP association is established, the target IAB-donor 108B transmits 542 downlink data for the UE 102, received from the source IAB-donor 108A or the CN 110, via the IAB-node 104 to the UE 102 without via the source IAB-donor 108A. More specifically, the target IAB-donor 108B perform security protection 542 on the downlink data (e.g., protect integrity of the downlink data and/or encrypt the downlink data) by using the third security key(s) (e.g., third encryption key and/or third integrity key) and transmits the security protected downlink data to the IAB-node 104, which in turn transmits the security protected downlink data to the UE 102 directly or via one or more intermediate IAB-nodes. After receiving the security protected downlink data, the UE 102 decrypts 542 and/or performs 542 integrity check on the security protected downlink data by using the third security key(s) (same as the third security key(s) used by the target IAB-donor 108B). Example implementations of using integrity protection and/or encryption are as described above.

After the UP association is established, the IAB-node 104 sends 542 uplink data, received from the UE 102 to the target IAB-donor 108B instead of the source IAB-donor 108A. More specifically, the UE 102 performs security protection on the uplink data (e.g., protect integrity of the uplink data and/or encrypt the uplink data) by using the third security key(s) and transmits the security protected uplink data to the IAB-node 104, which in turn transmits the security protected uplink data to the target IAB-donor 108B instead of the source IAB-donor 108A. After receiving the security protected uplink data, the target IAB-donor 108B decrypts 542 and/or performs 542 integrity check on the security protected uplink data by using the third security key(s) (same as the third security key(s) used by the UE 102). Example implementations of using integrity protection and/or encryption are as described above.

The target IAB-donor 108B can perform a data communication procedure with each of the other UE(s), similar to the data communication procedure 542.

In some implementations, the target IAB-donor 108B can send a PATH SWITCH REQUEST message for the UE 102 to the CN 110, after receiving the RRC reconfiguration complete message 526 or 544, and before, during or after the IAB-node handover procedure 560. The CN 110 performs path switch and sends a PATH SWITCH REQUEST ACKNOWLEDGE message to the target IAB-donor 108B in response to the PATH SWITCH REQUEST message. After performing the path switch, the CN 110 can send downlink data for the UE 102 to the target IAB-donor 108B, which in turn sends the downlink data to the source IAB-donor 108A at event 528 or to the IAB-node 104 at event 542 as described above. In one implementation, the CN 110 may immediately stop sending downlink data for the UE 102 to the source IAB-donor 108A in response to the path switch. In another implementation, the CN 110 may continue sending downlink data for the UE 102 to the source IAB-donor 108A for a while after the path switch. After receiving the PATH SWITCH REQUEST ACKNOWLEDGE message, the target IAB-donor 108B can send uplink data received from the UE 102 at event 542 to the CN 110 instead of the source IAB-donor 108A. In one implementation, the CN 110 may immediately stop sending downlink data for the UE 102 to the source IAB-donor 108A in response to the path switch. In another implementation, the CN 110 may continue sending downlink data for the UE 102 to the source IAB-donor 108A for a while after the path switch. In some implementations, the target IAB-donor 108B can perform an individual patch switch for each of the UE(s) handing over from the source IAB-donor 108A to the target IAB-donor 108B, as described above. In other implementations, the target IAB-donor 108B can perform a single patch switch for multiple UE(s) handing over from the source IAB-donor 108A to the target IAB-donor 108B, as described above.

In some implementations, the Handover Request message includes UE Context information of UE(s) (e.g., UE 102 and/or other UE(s)) and/or IAB-node 104, and IAB information. The target IAB-donor 108B can generate the RRC reconfiguration message(s) for the UE(s) and IAB-node 104 in accordance with the UE Context information. The target IAB-donor 108B can transmit or route DL PDUs for the UE(s) to the IAB-node 104 in accordance with the IAB information. For example, the IAB information includes topology and backhaul related information, IP address information of the IAB-node 104 and intermediate IAB-node(s) (if existing) and/or identity(ies) of the IAB-node 104 and intermediate IAB-node(s) (if existing). The topology and backhaul related information may include information such as the BAP mapping configuration, which contains the backhaul routing information (e.g., the BAP Routing ID, BAP address(es)) and/or traffic mapping information. The BAP address(es) can include next-hop BAP address(es).

In some implementations, the UE Context information of a particular UE (e.g., UE 102) or IAB-node 104 may include the NG-C UE associated Signaling Reference, Signaling TNL association address at source NG-C side, UE Security Capabilities, AS security information, Index to RAT/Frequency Selection Priority, Location Reporting Information, UE Aggregate Maximum Bit Rate, PDU Session Resources To Be Setup List, RRC Context, UE Context Reference at the IAB-node (e.g., Global NG-RAN Node ID, GNB-DU UE F1AP ID). In some implementations, the Handover Request Acknowledge message includes one or more RRC reconfiguration messages for the IAB-MT function of the IAB-nodes and/or UEs. In one implementation the Handover Request message and the Handover Request Acknowledge message for group handover as mentioned above can be new X2AP or XnAP interface messages for migrating the IAB-nodes and UEs other than the current Handover Request message and the Handover Request Acknowledge message defined in TS 36.423 or TS 38.423.

In some implementations, the AS security information can include a Key NG-RAN Start value and/or a Next Hop Chaining Count value. The target IAB-donor 108B can use the AS security information for the UE 102 to generate the third security key(s).

In some implementations, the IAB information is not carried in a Handover Request message but in another new interface message (e.g., X2AP or XnAP message IAB Information Transfer message). The source IAB-donor 108A can send the new interface message to the target IAB-donor 108B before or after transmitting the Handover Request message or receiving the Handover Request Acknowledge message.

In some implementations, the UE Context Request message and the UE Context Response message can be a UE Context Setup Request and a UE Context Setup Response message respectively. In other implementations, the UE Context Request message and the UE Context Response message can be a UE Context Modification Request and a UE Context Modification Response message respectively. In some implementations, the UE Context Request message includes the BH RLC Channel to Be Setup (or Modified) List which may include the BH RLC CH ID, BH RLC CH QoS or E-UTRAN BH RLC CH QoS, Control Plane Traffic Type, RLC Mode, BAP Control PDU Channel, Traffic Mapping Information. The UE Context Request message may also include DRB to Be Setup (or Modified) List and BAP Address as defined in TS 38.473.

In some implementations, the source AS configuration (i.e., the first source AS configuration, second AS configuration, third AS configuration or fourth AS configuration) includes physical layer configuration parameters, MAC layer configuration parameters and/or RLC configuration parameters. The Handover Request message or the first source AS configuration can include a PDCP configuration, a SDAP configuration and/or a radio bearer configuration (e.g., a RadioBearerConfig information element (IE)) that the IAB-node 104 used to communicate with the source IAB-donor 108A. The Handover Request message or the second source AS configuration can include the source IAB-donor configuration which includes a PDCP configuration, a SDAP configuration and/or a radio bearer configuration (e.g., a RadioBearerConfig IE). In some implementations, the source AS configuration includes configuration parameters in an RRCReconfiguration message, RRCReconfiguration-IEs, or the CellGroupConfig IE conforming to 3GPP TS 38.331. In one implementation, the AS configuration can be an RRCReconfiguration message, RRCReconfiguration-IEs, or the CellGroupConfig IE conforming to 3GPP TS 38.331.

In some implementations, if the IAB-donor is a gNB, the RRC reconfiguration message and RRC reconfiguration complete message are an RRCReconfiguration message and an RRCReconfigurationComplete message, respectively.

By the techniques described in the above example scenario, during an inter-donor migration of an IAB-node, data communication can continue between the UEs and the source and target donors without holding data packets of the UEs too long at the target donor to violate QoS requirements (e.g., the target IAB-donor 108B holds data packets of the UEs connecting to the IAB-node 104 until the IAB-node 104 hands over to the target IAB-donor 108B). Thus, long data interruption caused by the inter-donor migration of an IAB-node the can be avoided.

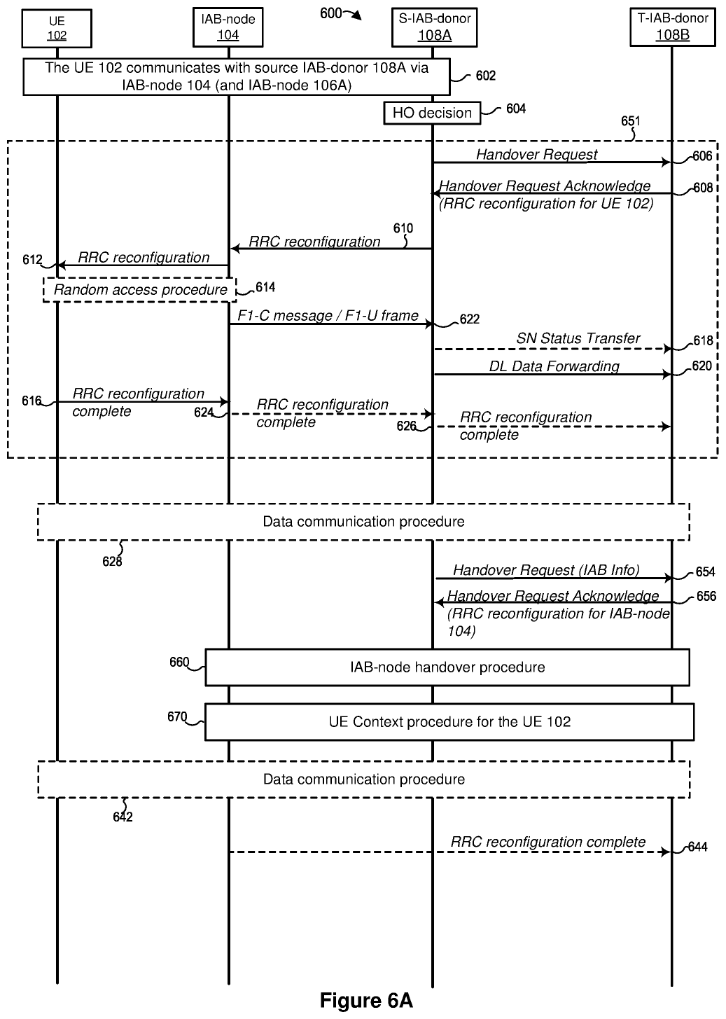

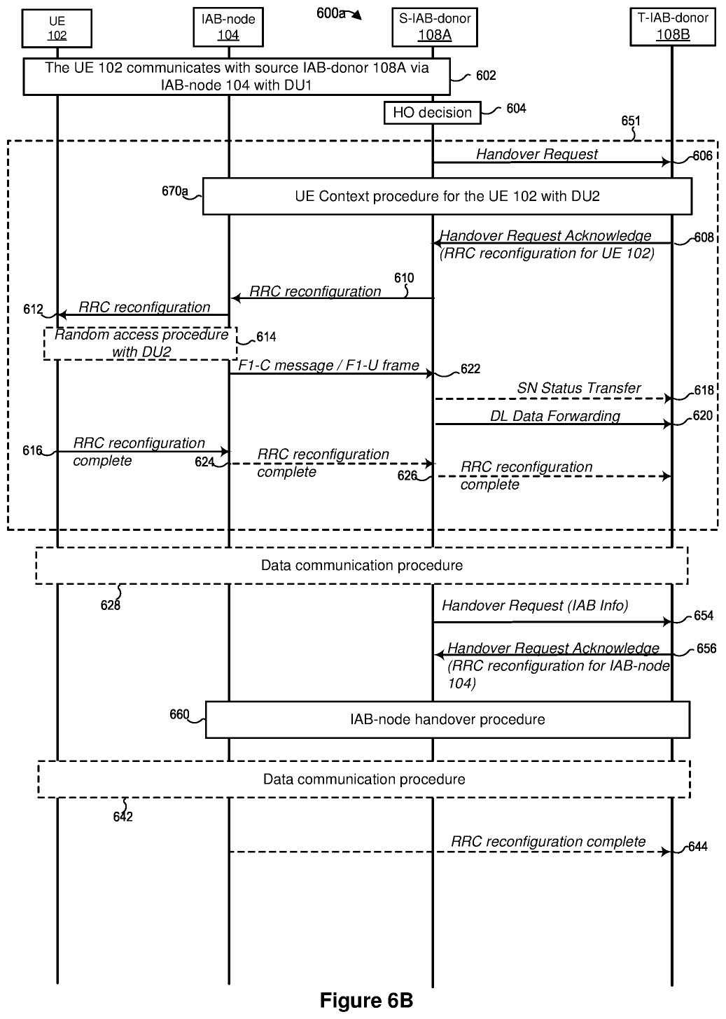

Referring next to FIG. 6, a scenario 600 also involves an inter-donor migration. The scenario 600 is similar to the scenario 500 but the handover preparation in the scenario 600 is done individually for each of the IAB-node 104, intermediate IAB-node(s) (if existing) or UE(s). Events in this scenario similar to those discussed above are labeled with similar reference numbers (e.g., with event 502 of FIG. 5 corresponding to event 602 of FIG. 6, with event 542 of FIG. 5 corresponding to event 642 of FIG. 6) and the examples and implementations for FIG. 5 can apply to FIG. 6. The differences between the scenarios of FIG. 5 and FIG. 6 are discussed below.

In the scenario 600, the source IAB-donor 108A at some point determines 604 that it should handover the IAB-node 104 and the UE 102 to the target IAB-donor 108B. In response to the determination, the source IAB-donor 108A uses an individual handover preparation procedure to prepare a handover for each of UE(s) (including the UE 102) connecting to the source IAB-donor 108A, the descendent IAB-node(s) (i.e., intermediate IAB node(s), if existing) of the IAB-node 104 and the IAB-node 104. In an individual handover preparation procedure for the UE 102 (i.e., prepare a handover for a single UE), the source IAB-donor sends 606 a Handover Request message for the UE 102 to the target IAB-donor 108B. In response, the target IAB-donor 108B sends 608 to the source IAB-donor 108A a Handover Request Acknowledge message including the RRC reconfiguration message for the UE 102. In the Handover Request message 606, the target IAB-donor 108B does not include an RRC reconfiguration message for other UE(s) and the IAB-node 104. The source IAB-donor 108A transmits the RRC reconfiguration message to the UE 102 via the IAB-node 104 and descendent IAB node(s) (if existing) at events 610 and 612, similar to events 510 and 512. After the UE 102 hands over to the target IAB-donor 108B according to the RRC reconfiguration message 610 as described for FIG. 5, the UE 102 and target IAB-donor 108B can perform 628 data communication procedure with each other, similar to the event 528.

In some implementations, in the Handover Request message, the source IAB-donor 108A includes the second source AS configuration and/or the second user plane setting for the UE 102 as described for the event 506. The source IAB-donor 108A may not include, in the Handover Request message, information irrelevant to the UE 102. Before performing the IAB-node handover procedure 660, the source IAB-donor 108A can perform a UE handover procedure for other UE(s) connecting to the source IAB-donor 108A via the IAB-node 104, similar to the UE handover procedure 651. The target IAB-donor 108B can perform a data communication procedure with each of the other UE(s), similar to the data communication procedure 628.

To perform an individual handover preparation procedure to prepare a handover for the IAB-node 104, the source IAB-donor sends 654 a Handover Request message for the UE 102 to the target IAB-donor 108B, similar to the event 506. In response, the target IAB-donor 108B sends 656 to the source IAB-donor 108A a Handover Request Acknowledge message including the RRC reconfiguration message for the IAB-node 104, similar to the event 508. The target IAB-donor 108B does not include an RRC reconfiguration message for other UE(s) and the descendent IAB-node(s) (if existing). The source IAB-donor 108A performs 660 IAB-node handover procedure with the IAB-node 104 and target IAB-donor 108B, similar to the IAB-node handover procedure 560. After the IAB-node 104 hands over to the target IAB-donor 108B in the IAB-node handover procedure 660, the UE 102 and target IAB-donor 108B can perform 642 data communication procedure with each other via the IAB-node 104, similar to the event 642.

In some implementations, in the Handover Request message, the source IAB-donor 108A includes the second source AS configuration for the UE 102 and/or the second user plane setting as described for event 506. The source IAB-donor 108A may not include, in the Handover Request message, information irrelevant to the UE 102. The source IAB-donor 108A can perform a UE handover procedure for other UE(s) connecting to the source IAB-donor 108A via the IAB-node 104, similar to the UE handover procedure 651. The target IAB-donor 108B can perform a data communication procedure with each of the other UE(s), similar to the data communication procedure 628.

In some implementations, the source IAB-donor 108A can prepare handover(s) for the UE(s) (including the UE 102) firstly, the descendent IAB-node(s) (if existing) secondly and the IAB-node 104 lastly. In other implementations, the source IAB-donor 108A can prepare handover(s) for the UE(s) (including the UE 102), the descendent IAB-node(s) (if existing) and the IAB-node 104 in any order.

The events 606, 608, 610, 612, 614, 616, 618, 620, 622, 624, 626 can be collectively referred as a UE handover (or migration) procedure 651. The source IAB-donor 108A can perform a UE handover procedure for other UE(s) connecting to the source IAB-donor 108A via the IAB-node 104, similar to the UE handover procedure 651. Then, the target IAB-donor 108B can perform a data communication procedure and a data communication procedure with each of the other UE(s), similar to the data communication procedures 628 and 642 respectively.

By the techniques described in the above example scenario, during an inter-donor migration of an IAB-node, data communication can continue between the UEs and the source and target donors without holding data packets of the UEs too long at the target donor to violate QoS requirements (e.g., the target IAB-donor 108B holds data packets of the UEs connecting to the IAB-node 104 until the IAB-node 104 hands over to the target IAB-donor 108B). Thus, long data interruption caused by the inter-donor migration of an IAB-node the can be avoided.

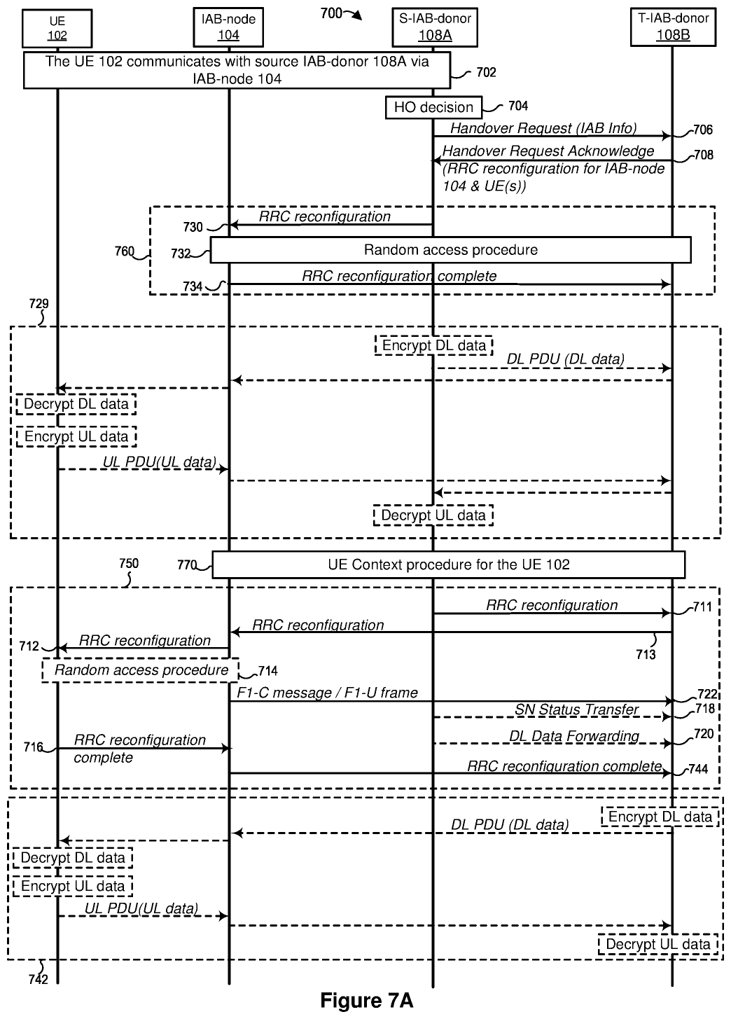

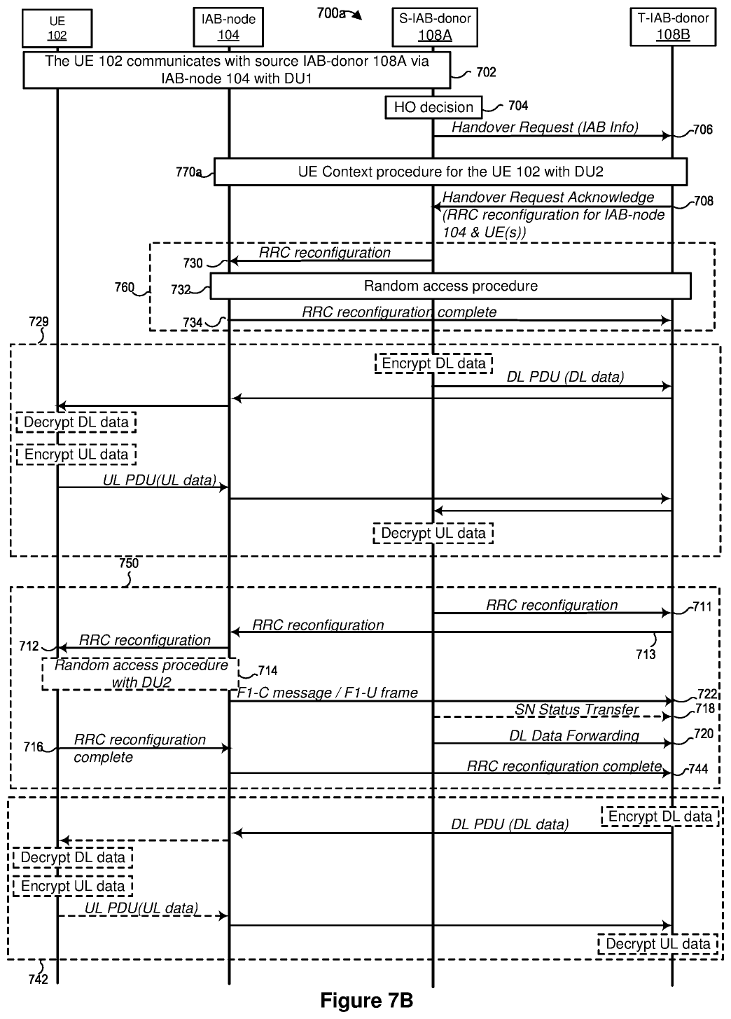

Now referring to FIG. 7, a scenario 700 also involves an inter-donor migration. The scenario 700 is similar to the scenario 500 but the IAB-node handover procedure is performed before the UE handover procedure. Events in this scenario similar to those discussed above are labeled with similar reference numbers (e.g., with event 502 of FIG. 5 corresponding to event 702 of FIG. 7, with event 542 of FIG. 5 corresponding to event 742 of FIG. 7) and the examples and implementations for FIG. 5 can apply to FIG. 7. The differences between the scenarios of FIG. 5 and FIG. 7 are discussed below.

In the scenario 700, the source IAB-donor 108A at some point determines 704 that it should handover the IAB-node 104 and its associated UE 102 to the target IAB-donor 108B. In response to this determination, the source IAB-donor sends 706 a Handover Request message to the target IAB-donor 108B, similar to the event 506. In response to receiving the Handover Request message, the target IAB-donor sends 708 a Handover Request Acknowledge message to the target IAB-donor 108B, similar to the event 708. After receiving the Handover Request Acknowledge message, the source IAB-donor 108A firstly performs 760 an IAB-node handover procedure to hand over the IAB-node 104 to the target IAB-donor 108B, similar to the IAB-node handover procedure 560. In some implementations, the S-IAB-donor 108A can send 706 to the T-IAB-donor 108B the Handover Request message for preparing a conditional handover (CHO) for the IAB-node 104. In this case, the T-IAB-donor 108B operates as a candidate IAB-donor (C-IAB-donor). In response, the C-IAB-donor 108B generates the RRC reconfiguration message for the IAB-node 104 as a CHO command. After receiving the RRC reconfiguration message for the IAB-node 104 in the Handover Request Acknowledge message 708, the S-IAB-donor 108A can generate a conditional configuration (e.g., CondReconfigToAddMode-r16 IE), which includes the RRC reconfiguration message for the IAB-node 104 and at least one condition for executing the RRC reconfiguration message for IAB-node 104. Then, the S-IAB-donor 108A transmits 730 the RRC container message including the conditional configuration to the IAB-node 104. When the IAB-node 104 receives the conditional configuration, the IAB-node 104 does not connect to the C-IAB-donor unless and until the IAB-node 104 detects that the corresponding condition(s) is satisfied. If the IAB-node 104 determines that the condition is satisfied, the IAB-node 104 connects to the C-IAB-donor 108B, such that the C-IAB-donor 108B becomes the T-IAB-donor 108B for the IAB-node 104.

In some implementations, the condition can be a signal strength/quality, as measured by the IAB-node 104 on a candidate primary cell (C-PCell) of the C-IAB-donor 108B (e.g., cell 128B) exceeding a first threshold, and/or a signal strength/quality, as measured by the IAB-node 104 on a PCell 128A of the S-IAB-donor 108B, exceeding a second threshold. For example, the condition may be satisfied if one or more measurement results obtained by the IAB-node 104 (when performing measurements on the C-PCell 128B) exceed a threshold that is configured by the S-IAB-donor 108A, or above a pre-determined or pre-configured first threshold, and/or if one or more measurement results obtained by the IAB-node 104 (when performing measurements on the PCell 128A) is below a threshold that is configured by the S-IAB-donor 108A, which can be a pre-determined or pre-configured second threshold. In other implementations, the condition can be that a signal strength/quality, as measured by the IAB-node 104 on the C-PCell 128B is exceeds a signal strength/quality, as measured by the UE 102 on the PCell 128A, by at least some threshold value (e.g., at least some offset). The threshold can be configured by the S-IAB-donor 108A, or can be a pre-determined or pre-configured offset, for example. In yet other implementations, the condition can be that a failure (e.g., radio link failure) occurs.

If the IAB-node 104 determines that condition is satisfied, the UE 102 may perform 732 the random access procedure with the C-IAB-donor 108B to connect to the C-IAB-donor 108B. After the IAB-node 104 successfully completes the random access procedure, the C-IAB-donor 108B becomes a T-IAB-donor for the IAB-node 104, and the C-PCell (e.g., cell 128B) becomes a PCell for the UE 102. In response to the RRC reconfiguration message (i.e., the CHO command) 730, the IAB-node 104 transmits 734 the RRC reconfiguration complete message during or after the random access procedure as described for event 534.

After the IAB-node 104 connects to the target IAB-donor 108B, the target IAB-donor 108B performs 770 a UE Context procedure for the UE 102 with the IAB-node 104, similar to the UE Context procedure 570. In some implementations, the IAB-node 104 can perform establishment of SCTP association(s) and/or F1 interface (e.g., F1 connection or F1 interface instance) with the target IAB-donor 108B so that the target IAB-donor 108B can perform the UE Context Setup procedure(s) on the F1 interface. The target IAB-donor 108B can establish an UP association for a DRB of the UE 102 before, during or after the UE Context procedure 770, e.g., by transmitting a DL USER DATA frame to the IAB-node 104, so that the target IAB-donor 108B can perform 729 data communication procedure as described below.

After receiving the Handover Request Acknowledge message, transmitting the RRC reconfiguration message 730, the IAB-node 104 disconnects from the source IAB-donor 108A to immediately hand over to the target IAB-donor 108B. Alternatively, determining the IAB-node 104 connects to the target IAB-donor 108B, the source IAB-donor 108A can transmit 729 downlink data for the UE 102, received from the CN 110, to the target IAB-donor 108B, which in turn transmits 729 the downlink data to the UE 102 via the IAB-node 104 and the descendent IAB-node(s) (if existing) after the IAB-node 104 connects to the target IAB-donor 108B. In some implementations, the transmission of downlink data 729 to the target IAB-donor 108B from the source IAB-donor 108A may involve transmission of downlink data to the donor-DU (i.e., not through the donor-CU) or the donor-CU of the target IAB-donor 108B from the source IAB-donor 108A. More specifically, the source IAB-donor 108A performs 729 security protection on the downlink data (e.g., protect integrity of the downlink data and/or encrypt the downlink data) by using fourth security key(s) and transmits 729 the security protected downlink data to the target IAB-donor 108B, which in turn transmits the security protected downlink data to the IAB-node 104. Then, the IAB-node 104 transmits 729 the security protected downlink data to the UE directly or via the intermediate IAB-node(s). After receiving the security protected downlink data, the UE 102 decrypts 729 and/or performs 729 integrity check on the security protected downlink data by using the fourth security key(s) (same as the fourth security key(s) used by the source IAB-donor 108A) to obtain the original downlink data.

In some implementations, the fourth security key(s) includes a fourth integrity key and a fourth encryption key. The source IAB-donor 108A performs 729 integrity protection for a downlink data packet, received from the CN 110, using the fourth integrity key to generate an integrity-protected downlink data packet (e.g., including the downlink data packet, and a MAC-I generated from the downlink data packet and the fourth integrity key), encrypt 729 the integrity-protected downlink data packet using the fourth encryption key, and send 729 a downlink PDU including the encrypted and integrity-protected downlink packet to the UE 102 via the target IAB-donor 108B, IAB-node 104 and the intermediate IAB-node(s) (if existing). After receiving the downlink PDU, the UE 102 extracts the encrypted and integrity-protected downlink packet, decrypt 729 the encrypted and integrity-protected downlink packet using the fourth encryption key to generate a decrypted integrity-protected downlink packet, and finally perform the integrity check on the decrypted integrity-protected downlink packet using the fourth integrity key to obtain the original downlink data packet (e.g. using the fourth integrity key to verify or validate the MAC-I).

In other implementations, the fourth security key is a fourth encryption key. The UE 102 and the source IAB-donor 108A don't apply integrity protection in data communication 702 and 729. The source IAB-donor 108A encrypts 729 a downlink data packet, received from the CN 110, using the third encryption key, and sends 729 a downlink PDU including the encrypted downlink packet to UE 102 via the target IAB-donor 108B and IAB-node 104. After receiving 729 the downlink PDU including the encrypted downlink packet, the UE 102 extracts the encrypted downlink packet form the downlink PDU, and decrypts 729 the encrypted data packet using the fourth encryption key to obtain the original downlink data packet.

Before the UE 102 hands over to the target IAB-donor 108B at event 750 (e.g., before receiving 712 the RRC reconfiguration message, completing 714 the random access procedure or transmitting 716 the RRC reconfiguration procedure), the UE 102 can transmit 729 uplink data to the target IAB-donor 108B via the IAB node 104. Then the target IAB-donor 108B forwards 729 the uplink data to the source IAB-donor 108A. More specifically, the UE 102 performs 729 security protection on the uplink data (e.g., protect integrity of the uplink data and/or encrypt the uplink data) by using the fourth security key(s) and transmits 729 the security protected uplink data to the target IAB-donor 108B via the IAB-node 104. Then the target IAB-donor 108B forwards 729 the security protected uplink data to the source IAB-donor 108A. After receiving the security protected uplink data, the source IAB-donor 108A decrypts 729 and/or performs 729 integrity check on the security protected uplink data by using the fourth security key(s) (same as the fourth security key(s) used by the UE 102) to obtain the original uplink data.

In some implementations, the UE 102 performs 729 integrity protection for an uplink data packet using the fourth integrity key to generate an integrity-protected uplink data packet (e.g., including the uplink data packet, and a MAC-I generated from the uplink data packet and the fourth integrity key), encrypt 729 the integrity-protected uplink data packet using the fourth encryption key, and send 729 an uplink PDU including the encrypted and integrity-protected uplink packet to the target IAB-donor 108B via the IAB-node 104. Then, the target IAB-donor 108B forwards the uplink PDU to the source IAB-donor 108A. After receiving the uplink PDU, the source IAB-donor 108A extracts the encrypted and integrity-protected uplink packet, decrypts 729 the encrypted and integrity-protected uplink packet using the fourth encryption key to generate a decrypted integrity-protected uplink packet, and finally performs the integrity check on the decrypted integrity-protected uplink packet using the fourth integrity key to obtain the original uplink data packet (e.g. using the fourth integrity key to verify or validate the MAC-I).

In other implementations, the UE 102 and the source IAB-donor 108A don't apply integrity protection. The UE 102 encrypts 729 an uplink data packet using the fourth encryption key, and sends 729 an uplink PDU including the encrypted uplink data packet to the IAB-node 104, which in turn transmits the encrypted uplink data packet to the target IAB-donor 108B. Then the target IAB-donor 108B transmits the encrypted uplink data packet to the source IAB-donor 108A. After receiving 729 the uplink PDU including the encrypted uplink data packet, the source IAB-donor 108A extracts the encrypted uplink data packet form the uplink PDU, and decrypt 729 the encrypted data packet using the fourth encryption key to obtain the original uplink data packet.

In some implementations, the target IAB-donor 108B can perform 729 the data communication procedure and 770 the UE Context procedure in parallel or one after the other.

In some implementations, the UE 102 communicates 702 data (e.g., uplink and/or downlink PDUs) with the source IAB-donor 108A via the IAB-node 104, by using fourth security key(s) similarly as described above. In some implementations, the target IAB-donor 108B can send a Handover Success message to the source IAB-donor 108A to indicate that the IAB-node 104 successfully hands over to the target IAB-donor 108B, after identifying the IAB-node 104 in the random access procedure or receiving the RRC reconfiguration complete message 734 in the IAB-node handover procedure. After receiving the Handover Success message, the source IAB-donor 108A can transmit 729 downlink data for the UE 102 to the target IAB-donor 108B as described above.

After the IAB-node handover procedure, the source IAB-donor 108A can transmit 711 the RRC reconfiguration message for the UE 102 to the target IAB-donor 108B, which in turn transmits 713 the RRC reconfiguration message to the IAB-node 104. Then, the IAB-node 104 transmits 714 the RRC reconfiguration message to the UE 102 directly or via the intermediate IAB-node(s) (if existing). The source IAB-donor 108A performs security protection on the RRC reconfiguration message (e.g., protect integrity of the RRC reconfiguration message and/or encrypt the RRC reconfiguration message) by using first security key(s) as described for FIG. 5. After receiving the security protected RRC reconfiguration message 712, the UE 102 decrypts and/or performs integrity check on the RRC reconfiguration message by using the first security key(s) (same as the first security key(s) used by the source IAB-donor 108A), and applies configuration parameters in the RRC reconfiguration message to hand over to the target IAB-donor 108B, as described for FIG. 5.

In some implementations, the UE 102 may perform 714 a random access procedure, if instructed in the RRC reconfiguration message, to the IAB-node 104. In response to the RRC reconfiguration message, the UE 102 performs security protection on an RRC reconfiguration complete message by using second security key(s) and sends 716 the security protected RRC reconfiguration complete message to the IAB-node 104 during or after the random procedure (if performed), as described for FIG. 5. The IAB-node 104, in response to the successful random access procedure 714 or the RRC reconfiguration complete message 716, sends 722 a F1-C message or a F1-U frame to the target IAB-donor 108B. In some implementation, the F1-C message or F1-U frame can be a Downlink (DL) Data Delivery Status frame as defined in 3GPP specification 38.425 or an Access Success message as defined in 3GPP specification 38.473.

After receiving the RRC reconfiguration complete message 716, the IAB-node 104 sends 744 the RRC reconfiguration complete message to the target IAB-donor 108B. The events 711, 713, 714, 716, 718, 720, 722, and 744 can be collectively referred as a UE handover (or migration) procedure 750.

If the Handover Request Acknowledge message includes second RRC reconfiguration message(s) for other UE(s), the target IAB-donor 108B can perform a data communication procedure, a UE Context procedure, a UE handover procedure, and/or another data communication procedure for each of the other UE(s), similar to 729 the data communication procedure, 770 the UE Context procedure, 750 the UE handover procedure, and/or 742 the data communication procedure, respectively.

By the techniques described in the above example scenario, during an inter-donor migration of an IAB-node, data communication can continue between the UEs and the source and target donors without holding data packets of the UEs too long at the intermediate IAB-node (e.g., IAB-node 104) to violate QoS requirements. Thus, long data interruption caused by the inter-donor migration of an IAB-node can be avoided.

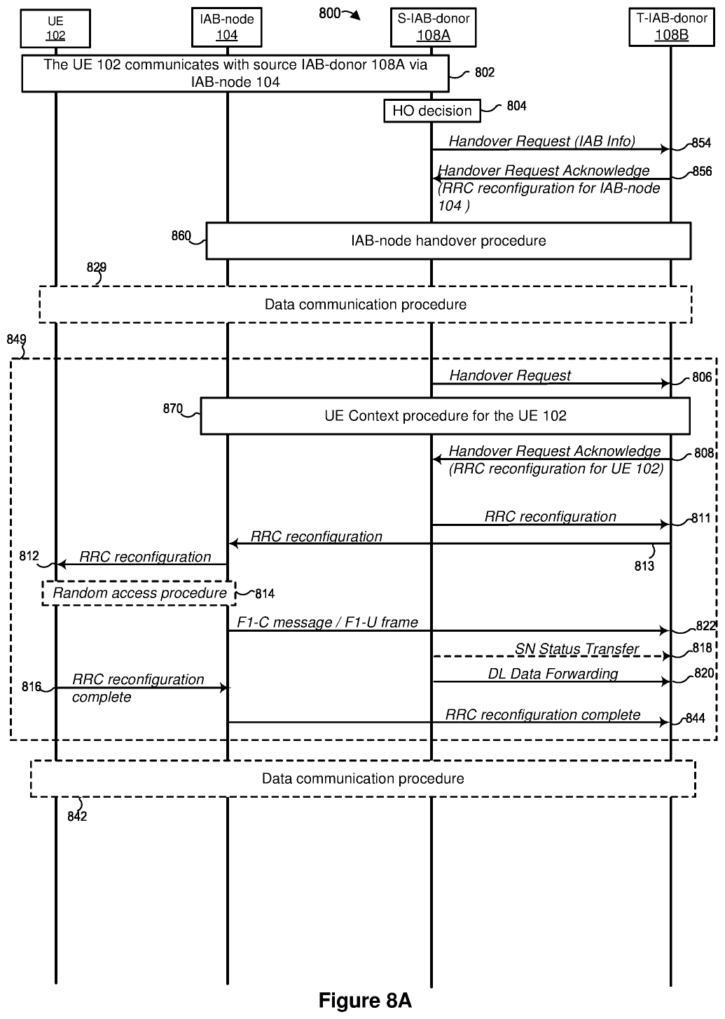

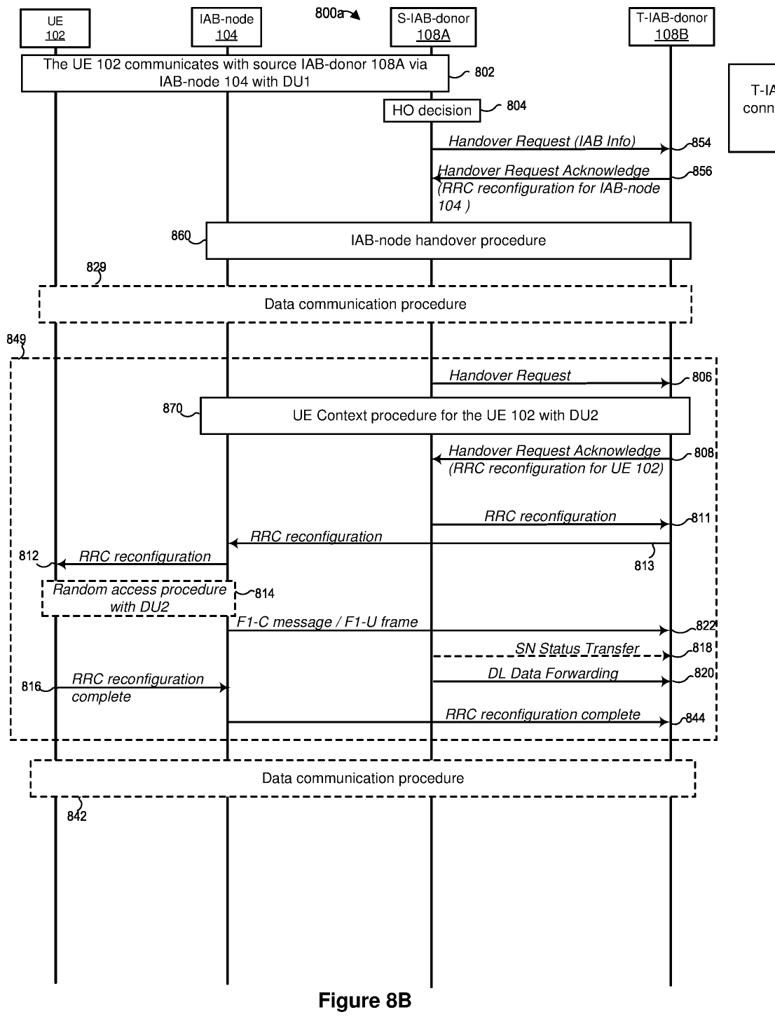

Now referring to FIG. 8, a scenario 800 also involves an inter-donor migration. The scenario 800 is similar to the scenarios 500-700. In the scenario 800, the handover preparation is performed individually for each of the IAB-node 104, intermediate IAB-node(s) (if existing), and their corresponding UE(s), and the IAB-node handover procedure is performed before the UE handover procedure. Events in this scenario similar to those discussed above are labeled with similar reference numbers (e.g., with event 502 of FIG. 5, event 602 of FIG. 6, and event 702 of FIG. 7 corresponding to event 802 of FIG. 8, with event 542 of FIG. 5, event 642 of FIG. 6, and event 742 of FIG. 7 corresponding to event 842 of FIG. 8) and the examples and implementations for FIGS. 5-7 can apply to FIG. 8. The differences between the scenarios of FIGS. 5-7 and FIG. 8 are discussed below.

In the scenario 800, the source IAB-donor 108A at some point determines 804 that it should hand over the IAB-node 104 and the served UE 102 to the target IAB-donor 108B. In response to the determination, the source IAB-donor 108A uses an individual handover preparation procedure to prepare a handover for each of UE(s) (including the UE 102) connected to the source IAB-donor 108A, the descendent IAB-node(s) (i.e., intermediate IAB node(s), if existing) of the IAB-node 104, and the IAB-node 104. In some implementations, the decision 804 may be performed one by one and separately for the involved node(s) instead of at the same time point. In an individual handover preparation procedure for the IAB-node 104, the source IAB-donor sends 854 a Handover Request message for the IAB-node 104 to the target IAB-donor 108B. In response, the target IAB-donor 108B sends 856 to the source IAB-donor 108A a Handover Request Acknowledge message including the RRC reconfiguration message for the IAB-node 104. The target IAB-donor 108B, however, does not include an RRC reconfiguration message for a UE. The source IAB-donor 108A performs 860 an IAB-node handover procedure with the IAB-node 104 and the target IAB-donor 108B, similar to the IAB-node handover procedure 560.

In some implementations, in the Handover Request message, the source IAB-donor 108A includes the first source AS configuration and/or the first user plane setting for the IAB-node 104 as described for the event 506. The source IAB-donor 108A may not include, in the Handover Request message, information irrelevant to the IAB-node 104. After performing the IAB-node handover procedure (i.e., the IAB-node 104 successfully connects to the IAB-donor 108B operating as a T-IAB-donor 108B or a C-IAB-donor 108B), the source IAB-donor 108A can perform 849 a UE handover procedure for each of UE(s) (including the UE 102) connected to the source IAB-donor 108A via the IAB-node 104, similar to a UE handover procedure 750. The source IAB-donor 108A can perform 829 a data communication procedure and 842 a data communication procedure with each of the UE(s), similar to the data communication procedures 729 and 742, respectively.

By the techniques described in the above example scenario, during an inter-donor migration of an IAB-node, data communication can continue between the UEs and the source and target donors without holding data packets of the UEs too long at the intermediate IAB-node (e.g., IAB-node 104) to violate QoS requirements. Thus, long data interruption caused by the inter-donor migration of an IAB-node can be avoided.

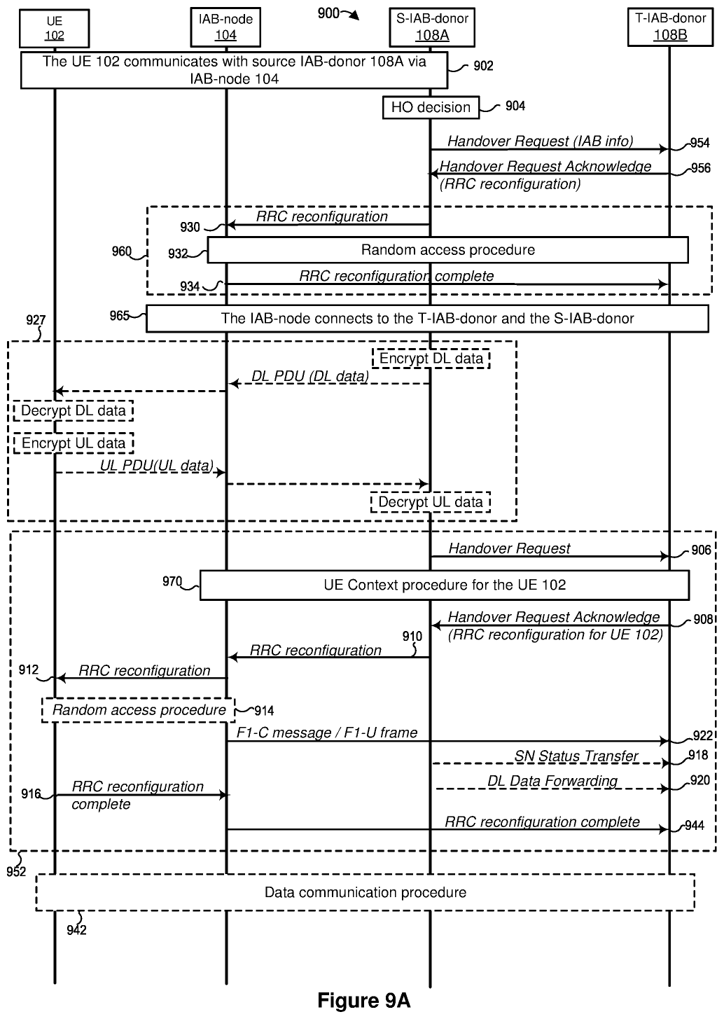

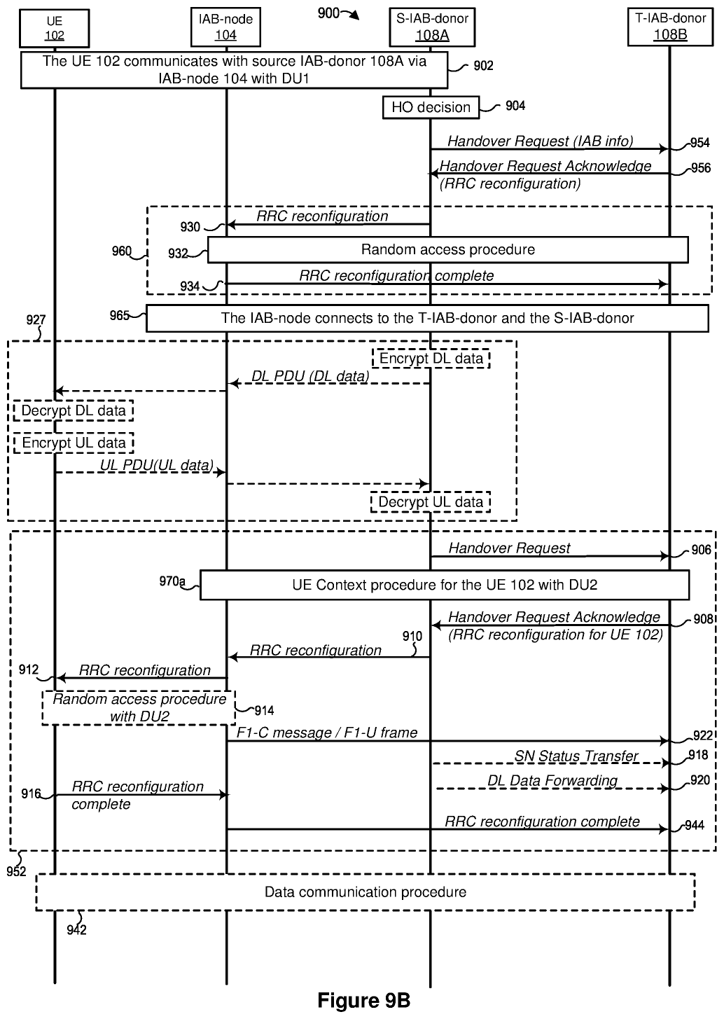

Referring next to FIG. 9, a scenario 900 similar to scenario 800, but the IAB-node connects to the target IAB-donor while keeps connecting with the source IAB-donor. Events in this scenario similar to those discussed above are labeled with similar reference numbers e.g., with event 502 of FIG. 5, event 602 of FIG. 6, event 702 of FIG. 7, event 802 of FIG. 8 corresponding to event 902 of FIG. 0, with event 542 of FIG. 5, event 642 of FIG. 6, event 742 of FIG. 7, and event 842 of FIG. 8 corresponding to event 942 of FIG. 9) and the examples and implementations for FIGS. 5-8 can apply to FIG. 9. The differences between the scenarios of FIG. 9 and FIGS. 5-8 are discussed below.

While the IAB-node performs 960 an IAB-node handover procedure with the target IAB-donor 108B, the IAB-node does not disconnect from the source IAB-donor 108A. After the IAB-node successfully hands over to the target IAB-donor 108B, the IAB-node 104 connects 965 to both the target IAB-donor 108B and source IAB-donor 108A. The target IAB-donor 108B can send a Handover Success message to the source IAB-donor 108A to indicate the IAB-node 104 successfully hands over to the target IAB-donor 108B. After the IAB-node 104 connects 965 to the target IAB-donor 108B, the source IAB-donor 108A can (still) transmit 927 downlink data for the UE 102, received from the CN 110, to the UE 102 via the IAB-node 104 and the descendent IAB-node(s) (if existing) without via the target IAB-donor 108B. More specifically, the source IAB-donor 108A performs security protection 927 on the downlink data (e.g., protect integrity of the downlink data and/or encrypt the downlink data) by using fourth security key(s) and transmits 927 the security protected downlink data to the UE 102. After receiving the security protected downlink data, the UE 102 decrypts 927 and/or performs 927 integrity check on the security protected downlink data by using the fourth security key(s) (same as the fourth security key(s) used by the source IAB-donor 108A) to obtain the original downlink data.

In some implementations, the fourth security key(s) includes a fourth integrity key and a fourth encryption key. The source IAB-donor 108A performs 927 integrity protection for a downlink data packet, received from the CN 110, using the fourth integrity key to generate an integrity-protected downlink data packet (e.g., including the downlink data packet, and a MAC-I generated from the downlink data packet and the fourth integrity key), encrypt 927 the integrity-protected downlink data packet using the fourth encryption key, and send 927 a downlink PDU including the encrypted and integrity-protected downlink data packet to the UE 102 via the IAB-node 104 and the intermediate IAB-node(s) (if existing). After receiving the downlink PDU, the UE 102 extracts the encrypted and integrity-protected downlink data packet, decrypt 927 the encrypted and integrity-protected downlink data packet using the fourth encryption key to generate a decrypted integrity-protected downlink data packet, and finally perform the integrity check on the decrypted integrity-protected downlink data packet using the fourth integrity key to obtain the original downlink data packet (e.g. using the third integrity key to verify or validate the MAC-I).

In other implementations, the fourth security key is a fourth encryption key. The UE 102 and the source IAB-donor 108A don't apply integrity protection in data communication 902 and 927. The source IAB-donor 108A encrypts 927 a downlink data packet, received from the CN 110, using the third encryption key, and sends 927 a downlink PDU including the encrypted downlink data packet to UE 102 via the IAB-node 104. After receiving 927 the downlink PDU including the encrypted downlink data packet, the UE 102 extracts the encrypted downlink data packet form the downlink PDU, and decrypts 927 the encrypted data packet using the fourth encryption key to obtain the original downlink data packet.

After completing 914 the random access procedure or transmitting 916 the RRC reconfiguration procedure, the UE 102 can transmit 927 uplink data to the IAB node 104, which in turn transmits 927 the uplink data to the source IAB-donor 108A. More specifically, the UE 102 performs 927 security protection on the uplink data (e.g., protect integrity of the uplink data and/or encrypt the uplink data) by using the fourth security key(s) and transmits 927 the security protected uplink data to the source IAB-donor 108A via the IAB-node 104. After receiving the security protected uplink data, the source IAB-donor 108A decrypts 927 and/or performs 927 integrity check on the security protected uplink data by using the fourth security key(s) (same as the fourth security key(s) used by the UE 102) to obtain the original uplink data.

In some implementations, the UE 102 performs 927 integrity protection for an uplink data packet using the fourth integrity key to generate an integrity-protected uplink data packet (e.g., including the uplink data packet, and a MAC-I generated from the uplink data packet and the third integrity key), encrypt 927 the integrity-protected uplink data packet using the fourth encryption key, and send 927 an uplink PDU including the encrypted and integrity-protected uplink packet to the IAB-node 104, which in turn transmits the encrypted and integrity-protected uplink packet to the source IAB-donor 108A. After receiving the uplink PDU, the source IAB-donor 108A extracts the encrypted and integrity-protected uplink packet, decrypt 927 the encrypted and integrity-protected uplink packet using the fourth encryption key to generate a decrypted integrity-protected uplink packet, and finally perform the integrity check on the decrypted integrity-protected uplink packet using the fourth integrity key to obtain the original uplink data packet (e.g. using the third integrity key to verify or validate the MAC-I).

In other implementations, the UE 102 and the source IAB-donor 108A don't apply integrity protection. The UE 102 encrypts 927 an uplink data packet using the fourth encryption key, and sends 927 an uplink PDU including the encrypted uplink data packet to source IAB-donor 108A via the IAB-node 104. After receiving 927 the uplink PDU including the encrypted uplink data packet, the source IAB-donor 108A extracts the encrypted uplink data packet form the uplink PDU, and decrypt 927 the encrypted data packet using the fourth encryption key to obtain the original uplink data packet.

In some implementations, the UE 102 communicates 902 data (e.g., uplink and/or downlink PDUs) with the source IAB-donor 108A via the IAB-node 104, by using fourth security key(s) similarly as described above. In some implementations, the target IAB-donor 108B can send a Handover Success message to the source IAB-donor 108A to indicate that the UE 102 successfully hands over to the target IAB-donor 108B, after identifying the UE 102 in the random access procedure 932 or receiving the RRC reconfiguration complete message 934.

After the IAB-node handover procedure or receiving the Handover Success message, the source IAB-donor 108A can perform 952 a UE handover procedure with the target IAB-donor 108B, the IAB-node 104 and the UE 102 to hand over the UE 102 to the target IAB-donor 108B. In some implementations, the source IAB-donor 108A can perform 927 the data communication procedure and 970 the UE Context procedure in parallel or one after the other. In other implementations, the source IAB-donor 108A can perform 927 the data communication procedure and 952 the UE handover procedure in parallel or before the UE 102 successfully hands over to the target IAB-donor 108B.

After the UE 102 hands over to the target IAB-donor 108B, the target IAB-donor 108B can perform 942 a data communication procedure with the UE 102, similar to the data communication procedure 542.

Similarly, after the IAB-node handover procedure, the source IAB-donor 108A can perform an individual UE handover procedure with the target IAB-donor 108B and the IAB-node 104 for other UE(s) connecting to the source IAB-donor 108A via the IAB-node 104, similar to the UE handover procedure 952. The source IAB-donor 108A can perform a data communication procedure for each of the other UE(s), similar to the data communication procedure 927, before the UE hands over to the target-donor IAB 108B. The source IAB-donor 108A can perform a data communication procedure for each of the other UE(s), similar to the data communication procedure 942, after the UE hands over to the target-donor IAB 108B.

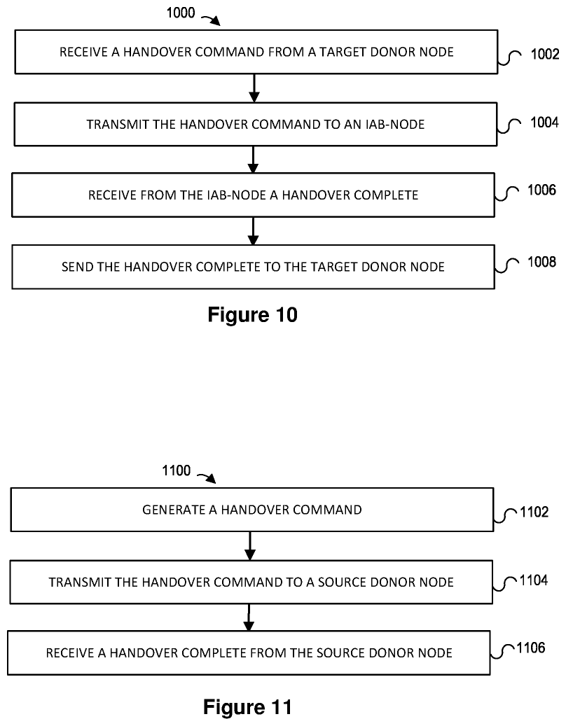

FIG. 10 illustrates an example method 1000 for forwarding the handover command to the IAB-node for the UE(s) and forwarding the handover complete to the target IAB-donor, which can be implemented in a source IAB-donor of FIGS. 5-6, for example.

The method 1000 begins at block 1002, where the donor node receives a handover command from a target donor node (event 508 of FIG. 5, 608 of FIG. 6). At block 1004, the donor node sends the handover command to an IAB-node (event 510 of FIG. 5, 610 of FIG. 6). The donor node at block 1006 receives from the IAB-node a handover complete (event 524 of FIG. 5, 624 of FIG. 6). The donor node at block 1008 sends the handover complete to the target donor node (event 526 of FIG. 5, 626 of FIG. 6).

FIG. 11 illustrates an example method 1100 for generating and transmitting a handover command and migrating the UE(s) and receiving a handover complete from the source donor node, which can be implemented in a target IAB-donor of FIGS. 5-6, for example.

The method 1100 begins at block 1102, where the donor node generates a handover command. At block 1104, the donor node sends the handover command to a source donor node (event 508 of FIG. 5, 608 of FIG. 6). The donor node at block 1106 receives from the source donor node a handover complete (event 526 of FIG. 5, 626 of FIG. 6).

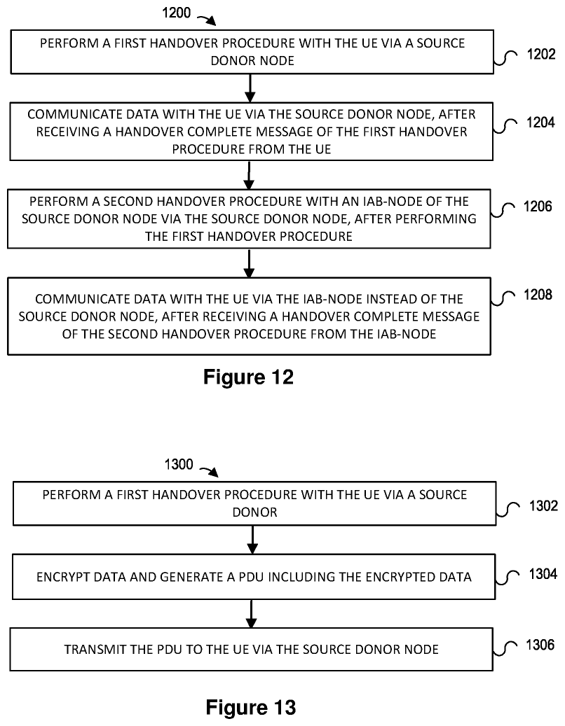

FIG. 12 illustrates an example method 1200 for performing the handover procedures with the UE(s) and the IAB-node and the data communication after the handover, which can be implemented in a target IAB-donor of FIGS. 5-6, for example.

The method 1200 begins at block 1202, where the donor node performs a first handover procedure with the UE via a source donor node (event 550 of FIG. 5, 650 of FIG. 6). At block 1204, the donor node communicates data with the UE via the source donor node after receiving a handover complete message of the first handover procedure from the UE (event 528 of FIG. 5, 628 of FIG. 6). The donor node at block 1206 performs a second handover procedure with an IAB-node of the source donor node via the source donor node, after performing the first handover procedure (event 560 of FIG. 5, 660 of FIG. 6). At block 1208, the donor node communicates data with the UE via the source donor node, after receiving a handover complete message of the first handover procedure from the UE (event 542 of FIG. 5, 642 of FIG. 6).

FIG. 13 illustrates an example method 1300 for performing the handover procedure with the UE(s) and the encryption of data communication after the handover, which can be implemented in a target IAB-donor of FIGS. 5-6, for example.

The method begins at block 1302, where the donor node performs a first handover procedure with the UE via a source donor (event 550 of FIG. 5, 650 of FIG. 6). At block 1304, the donor node encrypts data and generates a PDU including the encrypted data (event 528 of FIG. 5, 628 of FIG. 6). The donor node at block 1306 transmits the PDU to the UE via the source donor node (event 528 of FIG. 5, 628 of FIG. 6).

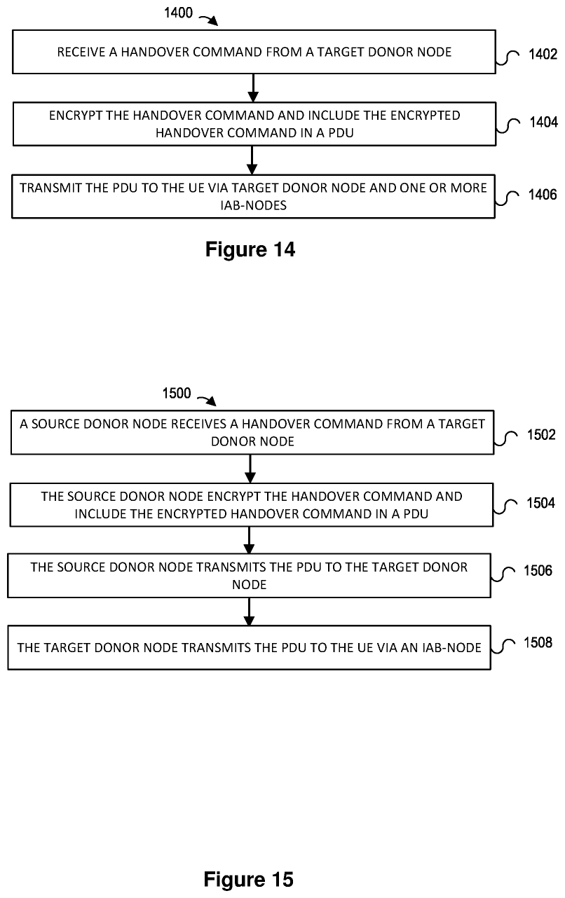

FIG. 14 illustrates an example method 1400 for performing the handover procedure with the UE(s) and the encryption of signaling communication, which can be implemented in a source IAB-donor of FIGS. 7-8, for example.

The method begins at block 1402, where the donor node receives a handover command from a target donor node (event 708 of FIG. 7, 856 of FIG. 8). At block 1404, the donor node encrypts the handover command and includes the encrypted handover command in a PDU. The donor node at block 1406 transmits the PDU to the UE via the target donor node and one or more IAB-nodes (event 711 of FIG. 7, 811 of FIG. 8).

FIG. 15 illustrates an example method 1500 for performing the handover procedure and the encryption of signaling communication, which can be implemented in an IAB supported RAN of FIGS. 7-8, for example.

The method begins at block 1502, where a source donor node receives a handover command from a target donor node (event 708 of FIG. 7, 856 of FIG. 8). The source donor node, at block 1504, encrypts the handover command and includes the encrypted handover command in a PDU. At block 1506, the source donor node transmits the PDU to the target donor node (event 711 of FIG. 7, 811 of FIG. 8). The target donor node at block 1508 transmits the PDU to the UE via an IAB-node (event 713 of FIG. 7, 813 of FIG. 8).

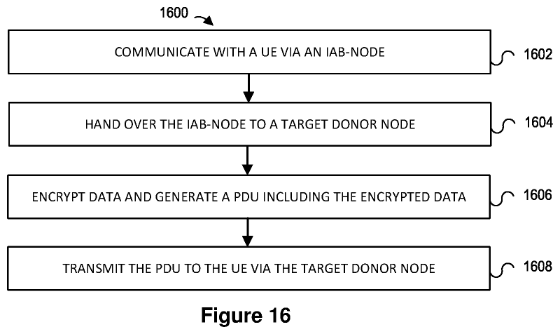

FIG. 16 illustrates an example method 1600 for performing handover procedure for the IAB-node and the encryption and data forwarding of the UE data communication, which can be implemented in a source IAB-donor of FIGS. 7-8, for example.

The method begins at block 1602, where a donor node communicates with a UE via an IAB-node (event 702 of FIG. 7, 802 of FIG. 8). The donor node at block 1604 migrates (hands over) the IAB-node to a target donor node (event 760 of FIG. 7, 860 of FIG. 8). The donor node at bock 1606 encrypts data and generates a PDU including the encrypted data (event 729 of FIG. 7, 829 of FIG. 8). The donor node at bock 1608 transmits the PDU to the UE via the target donor node (event 729 of FIG. 7, 829 of FIG. 8). In some implementations, the 1608 transmission of PDU to the UE via the target donor node may specifically involve the donor-DU of the target donor node (i.e., the PDU is transmitted from the source donor node to the donor-DU and the donor-CU is not involved). In other implementations, the 1608 transmission of PDU to the UE via the target donor node may specifically involve the donor-CU and the donor-DU of the target donor node (i.e., the PDU is transmitted from the source donor node to the donor-CU which then transmits the PDU to the donor-DU).

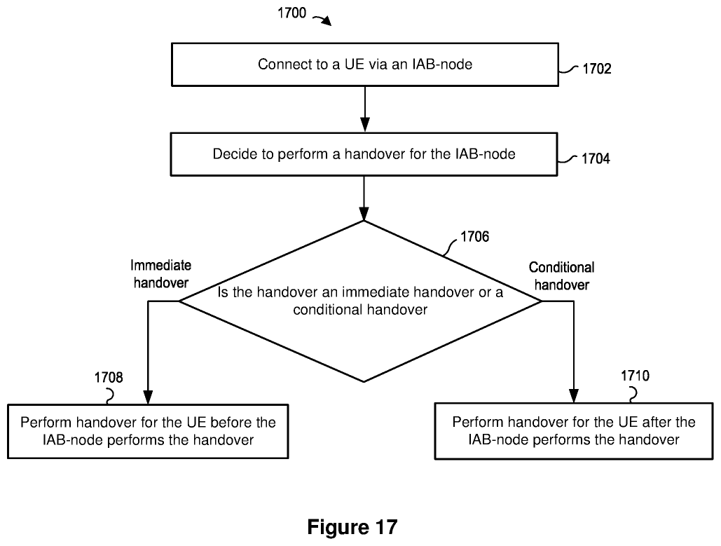

FIG. 17 illustrates an example method 1700 for performing handover procedure for the IAB-node and UE(s) connecting to the IAB-node, which can be implemented in a RAN (e.g., RAN 105 with an S-IAB-donor 108A and a T-IAB-donor 108B), for example.

The method begins at block 1702, where the RAN (e.g., the S-IAB-donor 108A) communicates with a UE via an IAB-node (event 502 of FIG. 5, event 602 of FIG. 6, event 702 of FIG. 7, event 802 of FIG. 8). The RAN (e.g., the S-IAB-donor 108A) at block 1704 determines to perform or performs a handover for the IAB-node 104 (events 504, 560 of FIG. 5 events 604, 660 of FIG. 6, events 704, 760 of FIG. 7, events 804, 860 of FIG. 8). The RAN (e.g., the S-IAB-donor 108A) at bock 1706 determines the handover is an immediate handover or a conditional handover. If the handover is an immediate handover, the RAN (e.g., the T-IAB-donor 108A) at bock 1708 performs handover for the UE (e.g., event 550 of FIG. 5, 651 of FIG. 6) before performing the handover with the IAB-node (e.g., event 560 of FIG. 5, 660 of FIG. 6). If the handover is a conditional handover, the RAN (e.g., the T-IAB-donor 108A) at bock 1710 performs handover for the UE (e.g., event 750 of FIG. 7, 849 of FIG. 8) after performing the handover with the IAB-node (e.g., event 760 of FIG. 5, 860 of FIG. 8).

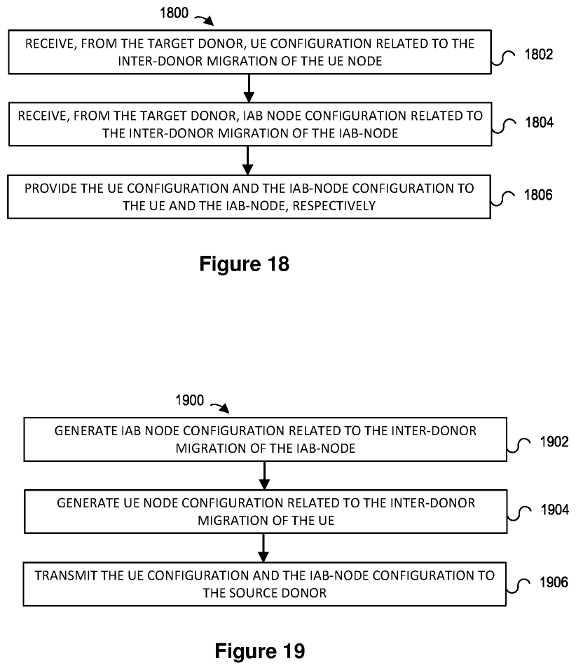

FIG. 18 is a flow diagram of an example method 1800, which in a source donor (e.g., S-IAB donor 108A) can implement to support inter-donor migration of an integrated access backhaul IAB node. At block 1802, the source donor receives a UE configuration related to inter-donor migration of the UE node (e.g., events 508, 608, 708, 808, 908). At block 1804, the source donor receives IAB-node configuration related to inter-donor migration of the IAB node (e.g., events 508, 656, 708, 854, 909). The source donor can execute blocks 1802 and 1804 in either order, or the source donor can receive this information at the same time. At block 1806, the source donor provides the UE configuration and the IAB-node configuration to the UE and the IAB-node, respectively (e.g., events 510, 530, 610, 730, 930). The source donor can provide these configurations in different respective messages in either order, depending on the implementation or scenario.

FIG. 19 is a flow diagram of an example method 1900, which in a target donor (e.g., T-IAB donor 108B) can implement to support inter-donor migration of an integrated access backhaul IAB node. At block 1902, the target donor generates an IAB-node configuration related to inter-donor migration of the UE node. At block 1904, the target donor generates a UE node configuration related to inter-donor migration of the UE. The target donor can execute blocks 1902 and 1904 in either order, or the source donor can receive this information at the same time. At block 1906, the target donor provides the UE configuration and the IAB-node configuration to the source node (e.g., events 508, 608, 656, 708, 808, 854, 908, 909). The target donor can provide these configurations in the same message or different respective messages in either order, depending on the implementation or scenario.

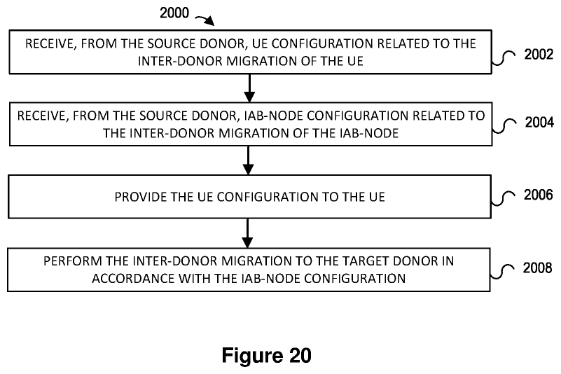

FIG. 20 is a flow diagram of an example method 2000, which the IAB-node 104 can implement to perform inter-donor migration. At block 2002, the IAB-node receives, from a source donor, a UE configuration related to the inter-donor migration of the UE node (e.g., events 510, 610, 730, 860). At block 2004, the IAB-node receives, from the source donor, an IAB node configuration related to the inter-donor migration of the IAB-node (events 510, 660, 730, 860). At block 2006, the IAB node provides the UE configuration to the UE (e.g., event 512, 612, 712, 812). At block 2008, the IAB-node performs the inter-donor migration to the target donor in accordance with the IAB-node configuration (e.g., event 560, 660, 760, 860).

The following description may be applied to the description above.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

The following list of examples reflects a variety of the embodiments explicitly contemplated by the present disclosure.

Example 1. A method in a source donor for supporting inter-donor migration of an IAB node from the source donor to a target donor, the source donor and the target donor corresponding to respective nodes of a RAN, when a UE is in communication with the RAN via the IAB-node, includes receiving, by processing hardware from the target donor, UE configuration related to the inter-donor migration of the UE node; receiving, by processing hardware from the target donor, IAB-node configuration related to the inter-donor migration of the IAB-node; and providing, by the processing hardware, the UE configuration and the IAB-node configuration to the UE and the IAB-node, respectively.

Example 2. The method of example 1, wherein the providing includes providing the UE configuration to the UE prior to providing the IAB-node configuration to the IAB-node.

Example 3. The method of example 2, wherein the providing includes transmitting, to the UE via the IAB-node, a first command to reconfigure a radio connection between the UE and the RAN, the first command including the UE configuration information; receiving, from the UE via the UE via the IAB-node, an indication that the UE has reconfigured the radio connection in accordance with the first command; and transmitting, to the IAB-node, a second command to reconfigure a radio connection between the IAB-node and the RAN, the second command including the IAB-node configuration information.

Example 4. The method of example 2 or 3, further comprising: prior to the IAB-node completing the inter-donor migration to the target donor, forwarding downlink data from the target donor to the UE.

Example 5. The method of example 1, wherein the providing includes providing the IAB-node configuration to the IAB-node prior to providing the UE configuration to the UE.

Example 6. The method of example 5, wherein the providing includes transmitting, to the UE via the IAB-node, a first command to reconfigure a radio connection between the IAB-node and the RAN, the first command including the IAB-node configuration information; determining, by the processing hardware, that the IAB-node has reconfigured the radio connection in accordance with the first command; and transmitting, to the UE node via the target donor, a second command to reconfigure a radio connection between the UE and the RAN, the second command including the UE configuration information.

Example 7. The method of example 5 or 6, further including prior to the UE completing the inter-donor migration to the target donor, transmitting downlink data for the UE to the target donor, for forwarding to the UE via the IAB-node.

Example 8. The method of example 5 or 6, further including: maintaining a connection with the source donor after the IAB-node has reconfigured the radio connection in accordance with the first command; and prior to the UE completing the inter-donor migration to the target donor, forwarding downlink data from the target donor to the UE

Example 9. The method of example 7 or 8, further comprising: applying, by the processing hardware to the downlink data, a security key shared with the UE.

Example 10. The method of any of the preceding examples, wherein receiving the UE configuration and the IAB-node configuration includes: receiving, from the target donor, a group handover command including the UE configuration and the IAB-node configuration.

Example 11. The method of example 10, further comprising: determining, by the processing hardware and prior to receiving the group handover command, that the source donor should hand the UE and the IAB-node over to the target donor; and transmitting, by the processing hardware to the target donor, a handover request message related to the IAB-node and the UE.

Example 12. The method of example 10 or 11, wherein receiving the group handover command includes receiving respective UE configuration for a plurality of UEs in communication with the RAN via the IAB-node.

Example 13. The method of any of examples 1-9, wherein receiving the UE configuration and receiving the IAB-node configuration includes: receiving a first handover command including one of the UE configuration or the IAB configuration; performing a first handover procedure corresponding to the first handover command; and receiving, subsequently to the first handover procedure, a second handover command including the second configuration.

Example 14. The method of example 13, wherein: receiving the first handover command is in response to transmitting, by the processing hardware to the target donor, a first handover request; and receiving the second handover command is in response to transmitting, by the processing hardware to the target donor, a second handover request.

Example 15. The method of any of the preceding examples, wherein providing the UE configuration to the UE includes applying, to a message including the UE configuration, a security key shared with the UE.

Example 16. The method of any of the preceding claims, further comprising: prior to receiving the UE configuration and prior to receiving the IAB-node configuration, transmitting, to the target donor, one or more of: (i) a first source access stratum (AS) configuration for the IAB-node, (ii) a second source AS configuration for the UE, (iii) transport layer information for the UE, (iv) Backhaul Adaptation Protocol (BAP) mapping configuration for the IAB-node, (v) BAP mapping configuration for one or more intermediate IAB-nodes via which the UE communicates with the RAN, (vi) a UE context for the UE, or (vii) a UE context for the IAB-node.

Example 17. A method in a target donor for supporting inter-donor migration of an IAB node from a source donor to the target donor, the source donor and the target donor corresponding to respective nodes of a RAN, when a UE is in communication with the RAN via the IAB-node, the method comprising: generating, by processing hardware of the target donor, UE configuration related to the inter-donor migration of the UE node; generating, by the processing hardware, IAB-node configuration related to the inter-donor migration of the IAB-node; and transmitting, by the processing hardware, the UE configuration and the IAB-node configuration to the source donor.

Example 18. The method of example 17, wherein the transmitting includes transmitting, by the processing hardware, a group handover message including the UE configuration and the IAB-node configuration.

Example 19. The method of example 18, further comprising: receiving, by the processing hardware from the source donor, a handover request message; wherein transmitting the group handover message is in response to receiving the handover request message.

Example 20. The method of example 17, wherein the transmitting includes: providing the UE configuration to the source donor prior to providing the IAB-node configuration to the source donor.

Example 21. The method of example 20, including: transmitting, by the processing hardware, a first handover command including the UE configuration to the source donor; receiving, by the hardware, an indication that the UE has reconfigured a radio connection with the RAN in accordance with the UE configuration; and subsequently to receiving the indication, transmitting a second handover command including the IAB-node configuration to the source donor.

Example 22. The method of example 17, wherein the transmitting includes: providing the IAB-node configuration to the source donor prior to providing the IAB-node configuration to the source donor.

Example 23. The method of example 22, including: transmitting, by the processing hardware, a first handover command including the IAB-node configuration to the source donor; receiving, by the hardware, an indication that the IAB-node has reconfigured a radio connection with the RAN in accordance with the IAB-node configuration; and subsequently to receiving the indication, transmitting a second handover command including the UE configuration to the source donor.

Example 24. The method of any of examples 17-23, further comprising: receiving, by the processing hardware, a first indication that the UE has reconfigured a radio connection with the RAN in accordance with the UE configuration; and receiving, by the processing hardware, a second indication that the IAB-node has reconfigured a radio connection with the RAN in accordance with the IAB-node configuration.

Example 25. The method of claim 24, wherein: the first indication is received prior to the second indication; the method further comprising: receiving downlink data addressed to the UE, from a core network, and forwarding the downlink data to the UE via the source donor, during a period of time between the first indication and the second indication.

Example 26. The method of claim 25, further comprising: applying, by the processing hardware to the downlink data, a security key shared with the UE.

Example 27. The method of claim 24, wherein: the second indication is received prior to the first indication; the method further comprising: receiving downlink data for the UE from the source donor; and forwarding the downlink data to the UE via the IAB-node, during a period of time between the second indication and the first indication.

Example 28. The method of any of examples 17-27, further comprising: determining, by the processing hardware, whether the IAB-node configuration pertains to immediate handover or conditional handover; in a first instance, when the IAB-node configuration pertains to immediate handover, causing the UE to perform the inter-donor migration to the target donor prior to the IAB-node performing the inter-donor migration to the target donor; and in a second instance, when the IAB-node configuration pertains to conditional handover, causing the IAB-node to perform the inter-donor migration to the target donor prior to the UE performing the inter-donor migration to the target donor.

Example 29. The method of any of examples 17-28, further comprising: prior to generating the UE configuration and prior to generating the IAB-node configuration, receiving, from the source donor, one or more of: (i) a first source access stratum (AS) configuration for the IAB-node, (ii) a second source AS configuration for the UE, (iii) transport layer information for the UE, (iv) Backhaul Adaptation Protocol (BAP) mapping configuration for the IAB-node, (v) BAP mapping configuration for one or more intermediate IAB-nodes via which the UE communicates with the RAN, (vi) a UE context for the UE, or (vii) a UE context for the IAB-node.

Example 30. A donor in an integrated access backhaul (IAB) topology of a radio access network (RAN), the donor including processing hardware and configured to implement a method of any the preceding examples.

Example 31. A method of inter-donor migration in an integrated access backhaul (IAB) node in communication with a source donor of a radio access network (RAN) via a first radio interface and with a user equipment (UE) via a second radio interface, the method comprising: receiving, by the processing hardware from the source donor, UE configuration related to the inter-donor migration of the UE to a target donor; receiving, by the processing hardware from the source donor, IAB-node configuration related to the inter-donor migration of the IAB-node to the target donor; providing, by the processing hardware, the UE configuration to the UE; and performing the inter-donor migration to the target donor in accordance with the IAB-node configuration.

Example 32. The method of example 31, wherein: the UE configuration is received prior to the IAB-node configuration.

Example 33. The method of example 32, further comprising: forwarding, to the source donor, an indication that the UE has reconfigured a radio connection with the RAN in accordance with the UE configuration; wherein the IAB configuration is received subsequently to the forwarding.

Example 34. The method of claim 32 or 33, further comprising, prior to completing the inter-donor migration of the IAB-node to the target donor: receiving downlink data for the UE from the source donor, and transmitting the downlink data to the UE.

Example 35. The method of claim 31, wherein: the IAB-node configuration is received prior to the UE configuration.

Example 36. The method of example 32, further comprising: forwarding, to the target donor, an indication that the IAB-node has reconfigured a radio connection with the RAN in accordance with the IAB-node configuration; wherein the UE configuration is received subsequently to the forwarding.

Example 37. The method of example 35 or 36, further comprising, prior to the UE completing the inter-donor migration to the target donor: receiving downlink data for the UE from the target donor, and transmitting the downlink data to the UE.

Example 38. The method of example 35 or 36, further comprising, prior to the UE completing the inter-donor migration to the target donor: maintaining a connection with the source donor; receiving downlink data for the UE from the source donor, and transmitting the downlink data to the UE.

Example 39. The method of any of examples 31-38, wherein: the IAB includes a first distributed unit (DU) and a second DU; the method further comprising: prior to receiving the UE configuration and the IAB-node configuration, providing a first connection between the UE and the source donor via the first DU, and providing a second connection between the UE and the target donor, in accordance with the UE configuration, via the second DU.

Example 40. The method of any of examples 31-39, wherein providing the UE configuration to the UE includes: performing, by the processing hardware, a random access procedure with the UE.

Example 41. The method of example 40, wherein performing the random access procedure includes using a new security key shared with the UE.

Example 42. A network device comprising processing hardware and configured to implement a method of any examples 31-41 to provide, in an integrated access backhaul (IAB) topology of a radio access network (RAN), functionality of an IAB-node.

What is claimed is:

1. A method in a source donor for supporting inter-donor migration of an integrated access backhaul (IAB) node from the source donor to a target donor, the source donor and the target donor corresponding to respective nodes of a radio access network (RAN), when a user equipment (UE) is in communication with the RAN via the IAB-node, the method comprising:
transmitting, by processing hardware to the target donor, a handover request message related to the IAB-node;
receiving, by the processing hardware from the target donor, a handover request acknowledge message including an IAB-node configuration related to the inter-donor migration of the IAB-node;
providing, by the processing hardware, the IAB-node configuration to the IAB-node; and
transmitting downlink data for the UE to the target donor, for forwarding to the UE via the IAB-node.

2. The method of claim 1, further comprising:
receiving, from the target donor, uplink data from the UE, for forwarding to a core network (CN).

3. The method of claim 1 or 2, further comprising:
receiving, by the processing hardware from the target donor, a UE configuration related to the inter-donor migration of the UE node; and
providing the UE configuration to the UE prior to providing the IAB-node configuration to the IAB-node.

4. The method of claim 3, wherein:
providing the UE configuration includes:
transmitting, to the UE via the IAB-node, a first command to reconfigure a radio connection between the UE and the RAN, the first command including the UE configuration information, and
receiving, from the UE via the UE via the IAB-node, an indication that the UE has reconfigured the radio connection in accordance with the first command; and
providing the IAB node configuration includes:
transmitting, to the IAB-node, a second command to reconfigure a radio connection between the IAB-node and the RAN, the second command including the IAB-node configuration information.

5. The method of claim 3, wherein:
providing the IAB-node configuration to the IAB-node occurs prior to providing the UE configuration to the UE.

6. The method of any of the preceding claims, further comprising:
applying, by the processing hardware to the downlink data, a security key shared with the UE.

7. The method of any of the preceding claims, wherein:
the handover request message and the handover request acknowledge message are associated with a first handover procedure;
the method further comprising:
performing a second handover procedure related to the UE.

8. The method of any of the preceding claims, further comprising:
prior to receiving the IAB-node configuration, transmitting, to the target donor, one or more of:
(i) a first source access stratum (AS) configuration for the IAB-node,
(ii) a second source AS configuration for the UE,
(iii) transport layer information for the UE,
(iv) Backhaul Adaptation Protocol (BAP) mapping configuration for the IAB-node,
(v) BAP mapping configuration for one or more intermediate IAB-nodes via which the UE communicates with the RAN,
(vi) a UE context for the UE, or
(vii) a UE context for the IAB-node.

9. A method in a target donor for supporting inter-donor migration of an integrated access backhaul (IAB) node from a source donor to the target donor, the source donor and the target donor corresponding to respective nodes of a radio access network (RAN), when a user equipment (UE) is in communication with the RAN via the IAB-node, the method comprising:
receiving, by processing hardware from the source donor, a handover request message related to the IAB-node;
transmitting, by the processing hardware to the source donor, a handover request acknowledge message including an IAB-node configuration related to the inter-donor migration of the IAB-node; and
receiving, from the source donor, downlink data for the UE; and
transmitting the downlink data to the UE via the IAB-node.

10. The method of claim 9, further comprising:
generating, by processing hardware of the target donor, UE configuration related to the inter-donor migration of the UE node; and
transmitting the UE configuration to the source donor.

11. The method of claim 10, including:
transmitting the UE configuration to the source donor prior to providing the IAB-node configuration to the source donor.

12. The method of claim 10, including:
transmitting the IAB-node configuration to the source donor prior to providing the UE configuration to the source donor.

13. The method of any of claims 9-12, further comprising:
applying, by the processing hardware to the downlink data, a security key shared with the UE.

14. The method of any of claims 9-13, further comprising:
determining, by the processing hardware, whether the IAB-node configuration pertains to immediate handover or conditional handover;
in a first instance, when the IAB-node configuration pertains to immediate handover, causing the UE to perform the inter-donor migration to the target donor prior to the IAB-node performing the inter-donor migration to the target donor; and
in a second instance, when the IAB-node configuration pertains to conditional handover, causing the IAB-node to perform the inter-donor migration to the target donor prior to the UE performing the inter-donor migration to the target donor.

15. A donor in an integrated access backhaul (IAB) topology of a radio access network (RAN), the donor including processing hardware and configured to implement a method of any the preceding claims.
